(19) United States
(12) Patent Application Publication
(10) Pub. No.: US 2024/0413303 A1
(43) Pub. Date: Dec. 12, 2024

(54) ELECTROCHEMICALLY-ACTIVE COMPOSITE PARTICLES FOR LITHIUM-ION BATTERIES AND METHODS THEREOF

(71) Applicant: Sila Nanotechnologies, Inc., Alameda, CA (US)

(72) Inventors: Joel SANCHEZ, Modesto, CA (US); Adam Paul KAJDOS, Alameda, CA (US); Eric John LACHMAN, Dublin, CA (US); Gleb Nikolayevich YUSHIN, Atlanta, GA (US)

(21) Appl. No.: 18/398,875

(22) Filed: Dec. 28, 2023

Related U.S. Application Data
(60) Provisional application No. 63/477,717, filed on Dec. 29, 2022.

(51) Int. Cl. H01M 4/36; H01M 4/02; H01M 4/04; H01M 4/1393; H01M 4/38; H01M 4/583; H01M 4/62; H01M 10/0525; H01M 10/058

(52) U.S. Cl. CPC H01M 4/364; H01M 4/0404; H01M 4/1393; H01M 4/386; H01M 4/583; H01M 4/625; H01M 10/0525; H01M 10/058; H01M 2004/021; H01M 2004/027; H01M 2004/028

(57) ABSTRACT

An aspect is directed to a battery electrode composition that includes a population of composite particles, in which each of the composite particles includes silicon and carbon. The population may be characterized by a particle size distribution (PSD) as determined by laser particle size distribution analysis (LPSA). In some embodiments, a tenth-percentile volume-weighted particle size parameter (D₁₀) of the PSD between about 0.8 μm to about 5.8 μm, a fiftieth-percentile volume-weighted particle size parameter (D₅₀) of the PSD between about 2.0 μm to about 9.0 μm, a ninetieth-percentile volume-weighted particle size parameter (D₉₀) of the PSD is at least about 3.2 μm, a left width (D₅₀-D₁₀) of the PSD is at least about 1.0 μm, and a right width (D₉₀-D₅₀) of the PSD is at least about 1.8 μm. Another aspect is directed to mixtures of composite particle populations with different particle sizes.

### CROSS-REFERENCE TO RELATED APPLICATIONS

The present application for patent claims the benefit of U.S. Provisional Application No. 63/477,717, entitled “OPTIMIZATION OF PARTICLE SIZE DISTRIBUTION CHARACTERISTICS OF ELECTROCHEMICALLY-ACTIVE COMPOSITE PARTICLES FOR LITHIUM-ION BATTERIES,” filed Dec. 29, 2022, assigned to the assignee hereof, and expressly incorporated herein by reference in its entirety.

### GOVERNMENT LICENSE RIGHTS

This invention was made with government support under contract number DE-EE0009186 awarded by the Office of Energy Efficiency and Renewable Energy (EERE) within the United States Department of Energy (DOE). The government has certain rights in the invention.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for applications in low- or zero-emission, hybrid-electric or fully-electric vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active materials may be produced as high-capacity (nano) composite powders (e.g., at least partially comprised of active material nanomaterials or nanostructures that may be embedded on and/or in a porous structure, such as a C-comprising matrix material), which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles includes anode particles with an average size (e.g., diameter or thickness) in the range of about 0.2 to about 40 microns (micrometers, or μm), as measured using laser particle size distribution analysis (LPSA), laser image analysis, electron microscopy, optical microscopy or other suitable techniques. Such a class of charge-storing particles offers great promises for scalable manufacturing and achieving high cell-level energy density and other performance characteristics.

Examples of electrode materials that exhibit moderately high volume changes (e.g., about 8-180 vol. %) during the first charge-discharge cycle and moderate volume changes (e.g., about 5-50 vol. %) during the subsequent charge-discharge cycles include (nano) composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorus, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

An example of low swelling particles may comprise the mixture of conversion silicon-based (or, broadly, silicon-comprising) anode active material-comprising particles with graphite-comprising particles, so-called silicon-graphite blends. In some examples of a blended anode, the Si-comprising anode active material particles may be Si-comprising and C-comprising nanocomposite (referred to herein as Si—C composite or Si—C nanocomposite or Si—C composite (or nanocomposite) particles, even if such particles comprise elements other than Si and C in relatively small quantities of less than about 10-20 at. %) is from about 20 to 80% by capacity, while the rest of the capacity is from graphite. In other examples, the Si—C composite (e.g., Si—C composite particles) may contribute more than about 80% or less than about 20% of the anode's capacity. Such anodes offer much higher volumetric and gravimetric energy density than the intercalation-type graphite anodes commonly used in commercial Li-ion batteries. In addition, in such a blended anode, the graphite may be composed of natural, artificial or a mixture of natural and artificial graphites. In some designs, it is more advantageous to use natural graphite or a mixture of natural and artificial graphites since such graphite particles are able to accommodate stresses caused by the high-swelling (during Li insertion) Si-based (e.g., Si—C) particles. Such properties of Si—C nanocomposite-graphite blends may offer overall moderate volume changes during the first cycle and low volume changes during the subsequent charging cycles. Such properties are advantageous for high-capacity loading anode particles, which may also reduce the cost of manufacturing of such battery cells.

In some designs, active electrode materials for use in electrochemical energy storage devices, such as batteries or electrochemical capacitors or hybrid devices, may be carbon-containing composite particles. A sub-class of such composite particles may include composite particles where conversion-type, alloying-type, intercalation-type or pseudocapacitive materials are confined within or infiltrated within carbon- or carbon-containing matrix material. However, existing approaches of synthesis or thermochemical processing of such carbon- or carbon-containing matrix materials can suffer from low efficiency, low packing density, low throughput, or insufficient control over uniformity or other limitations.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a battery electrode composition includes a population of composite particles, each of the composite particles comprising silicon and carbon; wherein: the population is characterized by a mass fraction of the silicon in the composite particles in a range of about 35 wt. % to about 70 wt. %; the population is characterized by a particle size distribution (PSD) as determined by laser particle size distribution analysis (LPSA) such that; a tenth-percentile volume-weighted particle size parameter (D₁₀) of the PSD is in a range of about 0.8 μm to about 5.8 μm; a fiftieth-percentile volume-weighted particle size parameter (D₅₀) of the PSD is in a range of about 2.0 μm to about 9.0 μm; a ninetieth-percentile volume-weighted particle size parameter (D₉₀) of the PSD is at least about 3.2 μm; a left width (D₅₀-D₁₀) of the PSD is at least about 1.0 μm; and a right width (D₉₀−D₅₀) of the PSD is at least about 1.8 μm.

In some aspects, the D₁₀ is in a range of about 0.8 μm to about 4.8 μm.

In some aspects, the D₁₀ is in a range of about 0.8 μm to about 4.5 μm.

In some aspects, the D₅₀ is in a range of about 2.7 μm to about 7.7 μm.

In some aspects, the D₅₀ is in a range of about 2.7 μm to about 7.3 μm.

In some aspects, the D₉₀ is at least about 5.0 μm.

In some aspects, the D₉₀ is at least about 8.0 μm.

In some aspects, the left width (D₅₀−D₁₀) is at least about 1.5 μm.

In some aspects, the left width (D₅₀−D₁₀) is at least about 3.3 μm.

In some aspects, the right width (D₉₀−D₅₀) is at least about 3.8 μm.

In some aspects, the right width (D₉₀−D₅₀) is at least about 4.4 μm.

In some aspects, the mass fraction of the silicon is in a range of about 40 wt. % to about 55 wt. %.

In some aspects, a Brunauer-Emmett-Teller (BET) specific surface area of the composite particles is in a range of about 1.5 m²/g to about 14.0 m²/g.

In some aspects, the BET specific surface area is in a range of about 2.3 m²/g to about 8.0 m²/g.

In some aspects, the composite particles are spheroidal.

In an aspect, a battery electrode includes a battery electrode composition disposed on and/or in a current collector, wherein: the battery electrode comprises a binder.

In some aspects, the battery electrode further comprises a carbon-comprising functional additive.

In some aspects, the carbon-comprising functional additive is selected from: carbon nanotubes, carbon nanofibers, carbon black, graphite, exfoliated graphite, graphene oxide, and graphene.

In some aspects, a mass fraction of the carbon-comprising functional additive is about 1.0 wt. % or less of a mass of the battery electrode.

In some aspects, the mass fraction of the carbon-comprising functional additive is about 0.2 wt. % or less.

In an aspect, a lithium-ion battery includes an anode current collector; a cathode current collector; a battery electrode configured as an anode, the current collector thereof being configured as the anode current collector; a cathode disposed on or in the cathode current collector; and an electrolyte ionically coupling the anode and the cathode.

In some aspects, the composite particles contribute 100% of a capacity of the anode.

In an aspect, a method of making a lithium-ion battery includes (E1) providing a battery electrode, the battery electrode being configured as an anode and the current collector being configured as an anode current collector; (E2) providing or making a cathode disposed on or in a cathode current collector; and (E3) assembling a battery cell from the anode and the cathode and filling a space between the anode and the cathode with an electrolyte ionically coupling the anode and the cathode to form the lithium-ion battery.

In an aspect, a method of making a battery electrode includes (C1) providing a battery electrode composition; and (C2) casting a slurry comprising the battery electrode composition on or in a current collector to form the battery electrode, wherein the slurry comprises a binder.

In an aspect, a method of making a lithium-ion battery includes (D1) making a battery electrode, the battery electrode being configured as an anode and the current collector being configured as an anode current collector; (D2) providing or making a cathode disposed on or in a cathode current collector; and (D3) assembling a battery cell from the anode and the cathode and filling a space between the anode and the cathode with an electrolyte ionically coupling the anode and the cathode to form the lithium-ion battery.

In an aspect, a method of making a battery electrode composition includes (A1) providing a first population of first composite particles, each of the first composite particles comprising silicon and carbon; (A2) providing a second population of second composite particles, each of the second composite particles comprising silicon and carbon; and (A3) mixing at least the first population and the second population in accordance with a population mass fraction, the population mass fraction being defined as a mass of the first population divided by a sum of the mass of the first population and a mass of the second population, to form the battery electrode composition, wherein: the first population is characterized by a first particle size distribution (PSD^{L}) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L} is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$\frac{{D}_{50}^{L}}{{D}_{50}^{S}} ,$$

the size ratio α being in a range of about 3.0 to about 6.0; and the population mass fraction is in a range of about 0.40 to about 0.95.

In some aspects, the D₅₀^{L}, is in a range of about 7.0 μm to about 9.0 μm.

In some aspects, the size ratio α is in a range of about 3.8 to about 5.2.

In some aspects, a mass fraction of the silicon in the first composite particles is in a range of about 3 wt. % to about 80 wt. %; and a mass fraction of the silicon in the second composite particles is in a range of about 3 wt. % to about 80 wt. %.

In some aspects, the first composite particles are spheroidal; and the second composite particles are spheroidal.

In some aspects, the (A3) additionally comprises mixing a carbon-comprising functional additive with the first population and the second population to form the battery electrode composition.

In some aspects, the carbon-comprising functional additive is selected from: carbon nanotubes, carbon nanofibers, carbon black, graphite, exfoliated graphite, graphene oxide, and graphene.

In an aspect, a method of making a battery electrode includes (B1) making a battery electrode composition; and (B2) casting a slurry comprising the battery electrode composition on and/or in a current collector to form the battery electrode, wherein the slurry comprises a binder.

In an aspect, a method of making a lithium-ion battery includes (F1) making a battery electrode, the battery electrode being configured as an anode and the current collector being configured as an anode current collector; (F2) providing or making a cathode disposed on or in a cathode current collector; and (F3) assembling a battery cell from the anode and the cathode and filling a space between the anode and the cathode with an electrolyte ionically coupling the anode and the cathode to form the lithium-ion battery.

In an aspect, a battery electrode composition includes a first population of first composite particles, each of the first composite particles comprising silicon and carbon; and a second population of second composite particles, each of the second composite particles comprising silicon and carbon; wherein: the first population and the second population are characterized by a population mass fraction being defined as a mass of the first population divided by a sum of the mass of the first population and a mass of the second population; the first population is characterized by a first particle size distribution (PSD^{L}) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L}. is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$\frac{{D}_{50}^{L}}{{D}_{50}^{S}} ,$$

the size ratio α being in a range of about 3.0 to about 6.0; and the population mass fraction is in a range of about 0.40 to about 0.95.

In some aspects, the D₅₀^{L} is in a range of about 7.0 μm to about 9.0 μm.

In some aspects, the size ratio α is in a range of about 3.8 to about 5.2.

In some aspects, a mass fraction of the silicon in the first composite particles is in a range of about 3 wt. % to about 80 wt. %; and a mass fraction of the silicon in the second composite particles is in a range of about 3 wt. % to about 80 wt. %.

In some aspects, the first composite particles are spheroidal; and the second composite particles are spheroidal.

In some aspects, a carbon-comprising functional additive.

In some aspects, the carbon-comprising functional additive is selected from: carbon nanotubes, carbon nanofibers, carbon black, graphite, exfoliated graphite, graphene oxide, and graphene.

In some aspects, the battery electrode position is in the form of a dry powder, a slurry suspension, or a casted electrode, or a lithium-ion battery.

An aspect is directed to a battery electrode composition comprising a population of composite particles, in which some or all of the composite particles comprise silicon (Si) and carbon (C), and may comprise other elements, such as nitrogen (N), phosphorus (P), boron (B), oxygen (O), hydrogen (H), sulfur(S), to name a few. In some embodiments, a total mass of the Si and the C may contribute from about 75 wt. % to about 100 wt. % of the total mass of the composite particles. Such composite particles are sometimes referred to herein as Si—C composites. In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. The population may be characterized by a particle size distribution (PSD) as determined by laser particle size distribution analysis (LPSA), image analysis of electron microscopy images, or other suitable techniques. The population may be characterized by a particle size distribution (PSD) as determined by laser particle size distribution analysis (LPSA) on well-dispersed particle suspensions in one example. Note that other types of particle size distribution (e.g., by SEM image analysis) could also be utilized (and may even lead to more precise measurements, in some experiments). In some embodiments, a tenth-percentile volume-weighted particle size parameter (D10) of the PSD is in a range of about 0.5 μm to about 6.0 μm (in some designs, from about 0.8 μm to about 5.8 μm; in other designs, from about 0.8 μm to about 4.8 μm; in yet other designs, from about 0.8 μm to about 4.5 μm). In some embodiments, a fiftieth-percentile volume-weighted particle size parameter (D₅₀) of the PSD is in a range of about 1.5 μm to about 12.0 μm (in some designs, from about 2.0 μm to about 9.0 μm; in other designs, from about 2.7 μm to about 7.7 μm; in yet other designs, from about 2.7 μm to about 7.3 μm; in yet other designs, from about 2.7 μm to about 12.0 μm; in yet other designs, from about 2.7 μm to about 9.0 μm). In some embodiments, a ninetieth-percentile volume-weighted particle size parameter (D₉₀) of the PSD is at least about 3.0 μm (in some designs, at least about 3.2 μm; in some other designs, at least about 5.0 μm; in yet some other designs, at least 8.0 μm). In some embodiments, the Doo of the PSD is at most about 20.0 μm (in some designs, at most about 20.0 μm; in some other designs, at most about 18.0 μm; in yet some other designs, at most about 16.0 μm; in yet some other designs, at most about 16.0 μm). In some embodiments, a left width (D₅₀−D₁₀) of the PSD is at least about 1.0 μm (in some designs, at least about 1.0 μm; in other designs, at least about 1.5 μm; in yet other designs, at least about 3.3 μm). In some embodiments, a right width (D₉₀−D₅₀) of the PSD is at least about 1.5 μm (in some designs, at least about 1.8 μm; in other designs, at least about 3.8 μm; in yet other designs, at least about 4.4 μm).

Another aspect is directed to a battery electrode composition comprising a population of nanocomposite particles, in which some or all of the composite particles comprise Si and C (so that the total mass of Si and C atoms contributes about 75 to about 100 wt. % of the nanocomposite particle mass), and the nanocomposite particles have certain characteristics. In some embodiments, a mass fraction of the silicon in the nanocomposite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 40 wt. % to about 45 wt. %). In some embodiments, a Brunauer-Emmett-Teller (BET) specific surface area (SSA) of the composite particles is in a range of in a range of about 1 m²/g to about 50 m²/g (in some designs, from about 1.5 m²/g to about 14.0 m²/g; in other designs, from about 2.3 m²/g to about 8.0 m²/g; in yet other designs, from about 1 to about 3 m²/g; in yet other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g). In some embodiments, the composite particles are round or substantially spherical or spheroidal.

Yet another aspect is directed to a battery electrode composition comprising a population of composite (e.g., nanocomposite) particles, in which some or all of the composite particles comprise silicon and carbon (so that the total mass of Si and C atoms contributes about 75 to about 100 wt. % of the nanocomposite particle mass). In some embodiments, the battery electrode composition may comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single walled carbon nanotubes (SWCNTs), multi-walled carbon nanotubes (MWCNTs)), carbon nanofibers, carbon black, graphite, exfoliated graphite, graphene oxide (e.g., single-walled graphene oxide, multi-walled graphene oxide), and graphene (e.g., single-walled graphene, multi-walled graphene). In some embodiments, the battery electrode composition may comprise one or more binders (in some designs, two or more binder components). In some embodiments, it is preferable to minimize the mass fraction of the binder(s) and the carbon-comprising functional additive(s), so that the mass fraction of the composite particles may be maximized. This “mass fraction” is expressed as a percentage of the mass of the respective electrode, excluding any current collector and/or any separator, even if the current collector and/or the separator are attached to the electrode. In some implementations, the mass fraction of the binder(s) is in a range of about 1 to about 15 wt. % (e.g., about 1 to about 3 wt. %, about 3 to about 5 wt. %, about 5 to about 7 wt. %, about 7 to about 9 wt. %, about 9 to about 11 wt. %, about 11 to about 13 wt. %, or about 13 to about 15 wt. %). In some implementations, the mass fraction of the carbon-comprising functional additive(s) is in a range of 0 to about 1.0 wt. % (e.g., 0 to about 0.2 wt. %, about 0.2 to about 0.4 wt. %, about 0.4 to about 0.6 wt. %, about 0.6 to about 0.8 wt. %, or about 0.8 to about 1.0 wt. %).

Yet another aspect is directed to a battery electrode. In some embodiments, the battery electrode comprises any of the foregoing battery electrode compositions, disposed on or in a current collector. In some embodiments, the battery electrode comprises a battery electrode composition and a binder. In some embodiments, a coating density of the battery electrode is in a range of about 0.8 to about 1.5 g/cm³ or in a range of about 0.8 to about 1.7 g/cm³ (in some designs, from about 0.8 to about 0.9 g/cm³; in other designs, from about 0.9 to about 1.0 g/cm³; in yet other designs, from about 1.0 to about 1.2 g/cm³; in yet other designs, from about 1.2 to about 1.5 g/cm³; in yet other designs, from about 0.9 to about 1.6 g/cm³; in yet other designs, from about 0.9 to about 1.2 g/cm³; in yet other designs, from about 0.9 to about 1.7 g/cm³). In some embodiments, a mass fraction of the silicon in the battery electrode is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs from about 5 wt. % to about 50 wt. %; in yet other designs from about 7 wt. % to about 40 wt. %; in yet other designs from about 9 wt. % to about 30 wt. %).

Yet another aspect is directed to a lithium-ion battery. In some embodiments, the lithium-ion battery comprises an anode current collector, a cathode current collector, any one of the foregoing battery electrodes configured as an anode disposed on or in the anode current collector, a cathode disposed on or in the cathode current collector, and an electrolyte ionically coupling the anode and the cathode.

Yet another aspect is directed a method of making a battery electrode composition, comprising stages (A1), (A2), and (A3). Stage (A1) comprises providing a first population of first composite (e.g., nanocomposite) particles, some or all of the first composite particles comprising silicon and carbon. Stage (A2) comprises providing a second population of second composite (e.g., nanocomposite) particles, some or all of the second composite particles comprising silicon and carbon. Each of the first and second populations of composite particles may comprise composite particles that constitute any of the foregoing battery electrode compositions. In some embodiments, the first population may be characterized by a first particle size distribution (PSD^{L}.) as determined by laser particle size distribution analysis (LPSA) on well-dispersed particle suspensions, and the second population may be characterized by a second particle size distribution (PSD^{S}) as determined by the LPSA on well-dispersed particle suspensions. In some embodiments, a fiftieth-percentile volume-weighted particle size parameter (D₅₀^{L}) of the PSD^{L} is in a range of about 5.0 μm to about 12.0 μm (in some designs, from about 6.0 μm to about 10.0 μm; in other designs, from about 7.0 μm to about 9.0 μm). In some embodiments, a fiftieth-percentile volume-weighted particle size parameter (D₅₀^{S}) of the PSD^{S} is related to the Do by a size ratio α defined as

$$α = \frac{{D}_{50}^{L}}{{D}_{50}^{S}} ,$$

the size ratio α being in a range of about 2.0 to about 7.0 (in some designs, from about 3.0 to about 6.0; in other designs, from about 3.8 to about 5.2). Stage (A3) comprises mixing at least the first population and the second population in accordance with a population mass fraction to form the battery electrode composition. The population mass fraction is defined as a mass of the first population divided by a sum of the mass of the first population and a mass of the second population. In some embodiments, the population mass fraction is in a range of about 0.20 to about 0.99 (in some designs, from about 0.20 to about 0.95; in other designs, from about 0.30 to about 0.95; in yet other designs, from about 0.40 to about 0.95; in yet other designs, from about 0.50 to about 0.95; in yet other designs, from about 0.60 to about 0.95; in yet other designs, from about 0.70 to about 0.9; in yet other designs, from about 0.55 to about 0.95; in yet other designs, from about 0.55 to about 0.90).

Yet another aspect is directed to a method of making a battery electrode composition, comprising the foregoing stages (A1), (A2), and (A3), in which the first composite particles and/or the second composite particles have certain characteristics. In some embodiments, a mass fraction of the silicon in the first composite particles and/or the second composite particles is in a range of about 3 wt. % to about 80 wt. %. (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 40 wt. % to about 45 wt. %; in yet other designs, from about 35 wt. % to about 70 wt. %; in yet other designs, from about 40 wt. % to about 55 wt. %). In some embodiments, a Brunauer-Emmett-Teller (BET) specific surface area (SSA) of the first composite particles and/or the second composite particles is in a range of in a range of about 1 m²/g to about 50 m²/g (in some designs, from about 1.5 m²/g to about 14.0 m²/g; in other designs, from about 2.3 m²/g to about 8.0 m²/g; in yet other designs, from about 1 to about 3 m²/g; in yet other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g). In some embodiments, the first composite particles and the second composite particles are round or substantially spherical. In some embodiments, the first composite particles or the second composite particles are round or substantially spherical or spheroidal.

Yet another aspect is directed to a method of making a battery electrode composition, comprising the foregoing stages (A1), (A2), and (A3). In some embodiments, stage (A3) additionally comprises mixing one or more carbon-comprising functional additives (e.g., additives that enhance electrical conductivity or rate performance of mechanical properties of the electrode) with the first population and the second population to make the battery electrode composition. In some embodiments, the carbon-comprising functional additive is selected from: carbon nanotubes (e.g., single walled carbon nanotubes (SWCNTs), multi-walled carbon nanotubes (MWCNTs)), carbon nanofibers, carbon black, graphite, exfoliated graphite, graphene oxide, and graphene.

Yet another aspect is directed to a method of making a battery electrode, comprising stages (B1) and (B2). Stage (B1) comprises making a battery electrode composition according to any of the foregoing methods of making a battery electrode composition. Stage (B2) comprises casting a slurry comprising the battery electrode composition on or in a current collector to form the battery electrode (note in some designs, this stage may often include evaporating the slurry solvent and/or densifying the battery electrode to a desired value). In some embodiments, the slurry comprises a binder. In some embodiments, a coating density of the battery electrode is in a range of about 0.8 to about 1.6 g/cm³ (in some designs, from about 0.8 to about 0.9 g/cm³; in other designs, from about 0.9 to about 1.0 g/cm³; in yet other designs, from about 1.0 to about 1.2 g/cm³; in yet other designs, from about 1.2 to about 1.5 g/cm³; in yet other designs, from about 0.9 to about 1.6 g/cm³; in yet other designs, from about 0.9 to about 1.2 g/cm³). In some embodiments, the battery electrode comprises a carbon-comprising functional additive. In some implementations, the carbon-comprising functional additive may be selected from: carbon nanotubes (e.g., SWCNT, MWCNT), carbon nanofibers, carbon black, graphite, exfoliated graphite, graphene oxide (e.g., single-walled graphene oxide, multi-walled graphene oxide) and graphene (e.g., single-walled graphene, multi-walled graphene). In some embodiments, a mass fraction of the silicon in the battery electrode is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 35 wt. % to about 70 wt. %; in yet other designs, from about 40 wt. % to about 55 wt. %).

Yet another aspect is directed to a method of making a battery electrode, comprising stages (C1) and (C2). Stage (C1) comprises providing any of the foregoing battery electrode compositions. Stage (C2) comprises casting a slurry comprising the battery electrode composition on or in a current collector to form the battery electrode (note in some designs, this stage may often include evaporating the slurry solvent and/or densifying the battery electrode to a desired value). In some embodiments, the slurry comprises a binder. In some embodiments, a coating density of the battery electrode is in a range of about 0.8 to about 1.5 g/cm³ (in some designs, from about 0.8 to about 0.9 g/cm³; in other designs, from about 0.9 to about 1.0 g/cm³; in yet other designs, from about 1.0 to about 1.2 g/cm³; in yet other designs, from about 1.2 to about 1.5 g/cm³). In some embodiments, the battery electrode comprises a carbon-comprising functional additive. In some implementations, the carbon-comprising functional additive may be selected from: carbon nanotubes (e.g., SWCNT, MWCNT), carbon nanofibers, carbon black, graphite, exfoliated graphite, graphene oxide and graphene. In some embodiments, a mass fraction of the silicon in the battery electrode is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 35 wt. % to about 70 wt. %; in yet other designs, from about 40 wt. % to about 55 wt. %).

Yet another aspect is directed to a method of making a lithium-ion battery, comprising stages (D1), (D2), and (D3). Stage (D1) comprises making a battery electrode according to any one of the foregoing methods of making a battery electrode, with the battery electrode being configured as an anode and the current collector being configured as the anode current collector. Stage (D2) comprises providing or making a cathode disposed on or in a cathode current collector. Stage (D3) comprises assembling a battery cell from the anode and the cathode (and, in some designs, a porous separator membrane or a porous separator layer(s) in between) and filling a space between the anode and the cathode with an electrolyte ionically coupling the anode and the cathode to form the lithium-ion battery.

Yet another aspect is directed to a method of making a lithium-ion battery, comprising stages (E1), (E2), and (E3). Stage (E1) comprises providing any of the foregoing battery electrodes, with the battery electrode being configured as an anode and the current collector being configured as the anode current collector. Stage (E2) comprises providing or making a cathode disposed on or in a cathode current collector. Stage (E3) comprises assembling a battery cell from the anode and the cathode and filling a space between the anode and the cathode with an electrolyte ionically coupling the anode and the cathode to form the lithium-ion battery.

In an aspect, a battery electrode composition includes a population of composite particles, each of the composite particles comprising silicon and carbon; wherein: the population is characterized by a particle size distribution (PSD) as determined by laser particle size distribution analysis (LPSA) such that; a tenth-percentile volume-weighted particle size parameter (D₁₀) of the PSD is in a range of about 0.8 μm to about 5.8 μm; a fiftieth-percentile volume-weighted particle size parameter (D₅₀) of the PSD is in a range of about 2.0 μm to about 9.0 μm; a ninetieth-percentile volume-weighted particle size parameter (D₉₀) of the PSD is at least 3.2 μm; a left width (D₅₀-D₁₀) of the PSD is at least 1.0 μm; and a right width (D₉₀−D₅₀) of the PSD is at least 1.8 μm.

In some aspects, the D₁₀ is in a range of about 0.8 μm to about 4.8 μm.

In some aspects, the D₁₀ is in a range of about 0.8 μm to about 4.5 μm.

In some aspects, the D₅₀ is in a range of about 2.7 μm to about 12.0 μm.

In some aspects, the D₅₀ is in a range of about 2.7 μm to about 9.0 μm.

In some aspects, the D₅₀ is in a range of about 2.7 μm to about 7.7 μm.

In some aspects, the D₅₀ is in a range of about 2.7 μm to about 7.3 μm.

In some aspects, the Doo is at least 5.0 μm.

In some aspects, the Doo is at least 8.0 μm.

In some aspects, the left width (D₅₀−D₁₀) is at least 1.5 μm.

In some aspects, the left width (D₅₀−D₁₀) is at least 3.3 μm.

In some aspects, the right width (D₉₀−D₅₀) is at least 3.8 μm.

In some aspects, the right width (D₉₀−D₅₀) is at least 4.4 μm.

In some aspects, a mass fraction of the silicon in the composite particles is in a range of about 3 wt. % to about 80 wt. %.

In some aspects, the mass fraction of the silicon is in a range of about 35 wt. % to about 70 wt. %.

In some aspects, the mass fraction of the silicon is in a range of about 35 wt. % to about 50 wt. %.

In some aspects, the mass fraction of the silicon is in a range of about 40 wt. % to about 55 wt. %.

In some aspects, a Brunauer-Emmett-Teller (BET) specific surface area of the composite particles is in a range of 1.5 m²/g to 14.0 m²/g.

In some aspects, the BET specific surface area is in a range of 2.3 m²/g to 8.0 m²/g.

In some aspects, the composite particles are round.

In an aspect, a battery electrode includes the battery electrode composition disposed on or in a current collector, wherein: the battery electrode comprises a binder.

In some aspects, a coating density of the battery electrode is in a range of about 0.9 to about 1.6 g/cm³.

In some aspects, a coating density of the battery electrode is in a range of about 0.9 to about 1.2 g/cm³.

In some aspects, a coating density of the battery electrode is in a range of about 0.9 to about 1.0 g/cm³.

In some aspects, a mass fraction of the silicon in the battery electrode is in a range of about 3 wt. % to about 80 wt. %.

In some aspects, a mass fraction of the silicon in the battery electrode is in a range of about 5 wt. % to about 50 wt. %.

In some aspects, a mass fraction of the silicon in the battery electrode is in a range of about 7 wt. % to about 40 wt. %.

In some aspects, a mass fraction of the silicon in the battery electrode is in a range of about 9 wt. % to about 30 wt. %.

In some aspects, the battery electrode further comprises a carbon-comprising functional additive.

In some aspects, the carbon-comprising functional additive is selected from: carbon nanotubes, carbon nanofibers, carbon black, graphite, exfoliated graphite, graphene oxide, and graphene.

In an aspect, a lithium-ion battery includes an anode current collector; a cathode current collector; the battery electrode configured as an anode, the current collector thereof being configured as the anode current collector; a cathode disposed on or in the cathode current collector; and an electrolyte ionically coupling the anode and the cathode.

In an aspect, a method of making a battery electrode composition includes (A1) providing a first population of first composite particles, each of the first composite particles comprising silicon and carbon; (A2) providing a second population of second composite particles, each of the second composite particles comprising silicon and carbon; and (A3) mixing at least the first population and the second population in accordance with a population mass fraction, the population mass fraction being defined as a mass of the first population divided by a sum of the mass of the first population and a mass of the second population, to form the battery electrode composition, wherein: the first population is characterized by a first particle size distribution (PSD^{L}) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L} is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$α = \frac{{D}_{50}^{L}}{{D}_{50}^{S}} ,$$

the size ratio α being in a range of about 3.0 to about 6.0; and the population mass fraction is in a range of about 0.40 to about 0.95.

In some aspects, the D₅₀^{L} is in a range of about 7.0 to about 9.0.

In some aspects, the size ratio α is in a range of about 3.8 to about 5.2.

In some aspects, a mass fraction of the silicon in the first composite particles is in a range of about 3 wt. % to about 80 wt. %; and a mass fraction of the silicon in the second composite particles is in a range of about 3 wt. % to about 80 wt. %.

In some aspects, the first composite particles are round; and the second composite particles are round.

In some aspects, the (A3) additionally comprises mixing a carbon-comprising functional additive with the first population and the second population to form the battery electrode composition.

In some aspects, the carbon-comprising functional additive is selected from: carbon nanotubes, carbon nanofibers, carbon black, graphite, exfoliated graphite, graphene oxide, and graphene.

In an aspect, a method of making a battery electrode includes (B1) making the battery electrode composition according to the method of (A1), (A2) and (A3); and (B2) casting a slurry comprising the battery electrode composition on or in a current collector to form the battery electrode, wherein the slurry comprises a binder.

In an aspect, a method of making a battery electrode includes (C1) providing the battery electrode composition; and (C2) casting a slurry comprising the battery electrode composition on or in a current collector to form the battery electrode, wherein the slurry comprises a binder.

In an aspect, a method of making a lithium-ion battery includes (D₁) making the battery electrode according to the method of (B1)-(B2) or (C1)-(C2), the battery electrode being configured as an anode and the current collector being configured as an anode current collector; (D2) providing or making a cathode disposed on or in a cathode current collector; and (D3) assembling a battery cell from the anode and the cathode and filling a space between the anode and the cathode with an electrolyte ionically coupling the anode and the cathode to form the lithium-ion battery.

In an aspect, a method of making a lithium-ion battery includes (E1) providing the battery electrode any of the foregoing battery electrode compositions, the battery electrode being configured as an anode and the current collector being configured as an anode current collector; (E2) providing or making a cathode disposed on or in a cathode current collector; and (E3) assembling a battery cell from the anode and the cathode and filling a space between the anode and the cathode with an electrolyte ionically coupling the anode and the cathode to form the lithium-ion battery.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIG. 2 is a flow diagram of a process of making a Li-ion rechargeable battery cell in accordance with certain embodiments.

FIG. 3 is a flow diagram of a process of making anode (or cathode) particles in accordance with certain embodiments including carrying out an activation process on carbon particles.

FIG. 4 is a flow diagram of a process of making a battery electrode composition in accordance with certain embodiments.

FIG. 5 shows an SEM image 502 of smaller composite particles (population sample A1) and an SEM image 504 of larger composite particles (population sample A7). Population samples A1 and A7 are related to each other by size ratio α of about 3.91.

FIG. 6 shows SEM images 602, 604 of populations of composite particles (A4, A5) obtained by mixing population samples A1 and A7 at larger particle mass fractions of about 0.60 and about 0.75, respectively.

FIG. 7 shows an SEM image 702 of smaller composite particles (population sample B1) and an SEM image 704 of larger composite particles (population sample B4). Population samples B1 and B4 are related to each other by size ratio α of about 4.49.

FIG. 8 shows SEM images 802, 804 of populations of composite particles (B2, B3) obtained by mixing population samples B1 and B4 at larger particle mass fractions of about 0.1 and about 0.7, respectively.

FIG. 9 shows an SEM image 902 of smaller composite particles (population sample C1) and an SEM image 904 of larger composite particles (population sample C5). Population samples C1 and C5 are related to each other by size ratio α of about 4.99.

FIG. 10 shows SEM images 1002, 1004 of populations of composite particles (C3, C4) obtained by mixing population samples C1 and C5 at larger particle mass fractions of about 0.75 and about 0.85, respectively.

FIG. 11 shows graphical plots 1102 of particle size distributions (PSDs) of each of the example populations of composite particles as discussed herein.

FIG. 12 shows SEM images 1202, 1204 of cross sections of electrode coatings comprising population samples A6 (α≈3.91, larger composite particle population mass fraction of about 0.85) and C3 (α≈4.99, larger composite particle population mass fraction of about 0.85), respectively.

FIG. 13 and FIG. 14 show, respectively, Table 1 (1302) and Table 2 (1402), which show selected particle characteristics, coating characteristics, and battery cell performance characteristics for each of the example populations of composite particles.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., from about −61° C. to about −60° C., as if the intervening numbers (in ° C.) between-120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “˜” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, alkaline batteries, flow batteries, etc.) as well as electrochemical capacitors and hybrid energy storage devices.

While the description below may describe certain examples in the context of composites comprising alloying-type anode active materials (such as Si, Sn, Sb, A1, among others), it will be appreciated that various aspects may be applicable to conversion-type anode and cathode active materials, intercalation-type anode and cathode active materials, pseudocapacitive anode and cathode active materials, and materials that may exhibit mixed electrochemical energy storage mechanisms. Note that high-capacity alloying-type (conversion-type) anode material choice may be different for Na and Na-ion, Mg and Mg-ion, K and K-ion, Ca and Ca-ion and Li or Li-ion. For example, while Si may be a preferred alloying-type material for Li or Li-ion batteries, Sn or Sb or Sn- or Sb-comprising alloys may be preferred alloying-type material(s) for Na or Na-ion batteries.

While the description below may also describe certain examples of the material formulations in a Li-free state (for example, as in silicon-comprising nanocomposite anodes or metal fluoride cathodes), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material
Property Measurements

| | | Measurement | |
|---|---|---|---|
| Material | Property | Instru- | |
| Type | Type | mentation | Measurement Technique |
| Active | Coulombic | Potentiostat | Charge (current) is passed to |
| Material | Efficiency | | an electrode containing the |
| | | | active material of interest until |
| | | | a given voltage limit is |
| | | | reached. Then, the current is |
| | | | reversed (discharge current) |
| | | | until a second voltage limit is |
| | | | reached. The ratio of the two |
| | | | charges passed determines the |
| | | | Coulombic Efficiency (CE). In |
| | | | the simplest case, the charge |
| | | | and discharge currents may be |
| | | | constant and often have |
| | | | absolute values that are the |
| | | | same or close to each other. It |
| | | | should be understood though |
| | | | that in some experiments, |
| | | | either charge current or |
| | | | discharge current or both may |
| | | | be changing during such |
| | | | experiments (e.g., be initially |
| | | | constant and when the voltage |
| | | | limit is reached, diminishing to |
| | | | a predetermined value). In |
| | | | addition, the absolute value of |
| | | | the charge and discharge |
| | | | currents may differ. |
| Active | Partial | Manometer | The partial vapor pressure of |
| Material | Vapor | | an active material in a mixture |
| | Pressure | | (e.g., composite particle) at a |
| | (e.g., | | particular temperature is given |
| | Torr.) at a | | by the known vapor pressure |
| | Temper- | | of the active material |
| | ature | | multiplied by its mole fraction |
| | (e.g., K) | | in the mixture. |
| Active | Volume | Gas | Gas pycnometer measures the |
| Material | | pycnometer | skeletal volume of a material |
| Particle | | | by gas displacement using the |
| | | | volume-pressure relationship |
| | | | of Boyle's Law. A sample of |
| | | | known mass is placed into the |
| | | | sample chamber and |
| | | | maintained at a constant |
| | | | temperature. An inert gas, |
| | | | typically helium, is used as the |
| | | | displacement medium. |
| | | | Note: A vol. % change may be |
| | | | calculated from two volume |
| | | | measurements of the active |
| | | | material particle. |
| Active | Open | nitrogen | Nitrogen sorption/desorption |
| Material | Internal | sorption/ | isotherm (typically at 77K) is |
| Particle | Pore | desorption | collected and analyzed to |
| | Volume | isotherm | estimate the total amount of |
| | (e.g., cc/g | | gas adsorbed/desorbed and |
| | or cm³/g) | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, | PSA using laser scattering, |
| Material | Average | scanning | electron microscopy (SEM, |
| Particle | Pore | electron | TEM, STEM) in combination |
| | Size and | microscope | with image analyses, laser |
| | Pore | (SEM), | microscopy (for larger |
| | Size | transmission | particles and larger pores) in |
| | Distributions | electron | combination with image |
| | (e.g., nm) | microscope | analyses, optical microscopy |
| | | (TEM), | (for larger particles and larger |
| | | scanning | pores), neutron scattering, X- |
| | | transmission | ray scattering, X-ray |
| | | microscope | microscopy imaging may be |
| | | (STEM), | employed to measure pore |
| | | laser | sizes (average pore size or |
| | | microscope, | pore size distribution) in |
| | | Synchrotron | different size ranges (in |
| | | X-ray, | addition to the analysis of the |
| | | X-ray | sorption/desorption isotherms). |
| | | microscope | |
| Active | Closed | Gas | Closed porosity may be |
| Material | Internal | pycnometer | measured by analyzing true |
| Particle | Pore | | density values measured by |
| | Volume | | using an argon gas pycnometer |
| | (e.g., | | and comparing them to the |
| | cc/g or | | theoretical density of the |
| | cm³/g) | | individual material |
| | | | components present in Si- |
| | | | comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas | With a pycnometer, the |
| Material | Internal | pycnometer | amount of a certain medium |
| Particle | Volume- | | (liquid or Helium or other |
| | Average | | analytical gases) displaced by |
| | Size | | a solid can be determined. |
| | (e.g., nm) | | |
| Active | Size | TEM, STEM, | Laser particle size distribution |
| Material | (e.g., | SEM, | analysis (LPSA), laser image |
| Particle | nm, μm, | X-Ray, | analysis, electron microscopy, |
| | etc.) | PSA, etc. | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), |
| | | | X-ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction | | mass fraction of a material in |
| | or wt. | | the particle relative to the total |
| | %, mg, | | particle mass. |
| | number of | | Note #2: The capacity |
| | atoms, etc.) | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be characterized |
| | | | by a number of atoms of a |
| | | | particular element (e.g., Fe, F, |
| | | | C, etc.). In case of atoms, the |
| | | | number of atoms may be |
| | | | estimated from the weight of |
| | | | that atom in the particle (e.g., |
| | | | based on gas chromatography) |
| Active | Composition | X-ray | |
| Material | (e.g., mass | Fluorescence | |
| Particle | fraction | (XRF), | |
| | or wt. | Inductively | |
| | % of various | Coupled | |
| | atomic | Plasma | |
| | elements or | Optical | |
| | molecules, | Emission | |
| | atomic | Spectroscopy | |
| | fraction or at. | (ICP- | |
| | % of various | OES); Energy | |
| | elements, | Dispersive | |
| | etc.) | Spectroscopy | |
| | | (EDS), | |
| | | Wavelength | |
| | | Dispersive | |
| | | Spectroscopy | |
| | | (WDS), | |
| | | Electron | |
| | | Energy Loss | |
| | | Spectroscopy | |
| | | (EELS), | |
| | | Nuclear | |
| | | Magnetic | |
| | | Resonance | |
| | | (NMR); | |
| | | Secondary | |
| | | Ion Mass | |
| | | Spectrometry | |
| | | (SIMS); | |
| | | X-Ray | |
| | | Photoelectron | |
| | | Spectroscopy | |
| | | (XPS); | |
| | | Fourier | |
| | | Transform | |
| | | Infrared | |
| | | Spectroscopy | |
| | | (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is charged |
| Battery | | | or discharged (by passing |
| Half- | | | electrical current to the |
| Cell | | | electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed |
| | | | by multiplying the total mass |
| | | | of the electrode by the active |
| | | | material mass fraction. Both |
| | | | reversible and irreversible |
| | | | capacity during charge or |
| | | | discharge may be calculated in |
| | | | this way. |
| Active | BET SSA | BET | A sample is placed into a |
| Material | (e.g., | instrument | sealed chamber at 77K, where |
| Particle | m²/g) | | nitrogen is introduced at |
| | | | increasing pressure. The |
| | | | change in pressure of the |
| | | | nitrogen is used to calculate |
| | | | the surface area of the sample. |
| Active | Aspect | SEM, TEM | The dimensions and shape of |
| Material | Ratio | | the particles are typically |
| Particle | | | measured by using SEM or |
| | | | TEM or (for large particles) by |
| | | | using optical microscopy. |
| Active | True | Argon Gas | True density values may be |
| Material | Density | Pycnometer | measured by using an argon |
| Particle | of Particle | | gas pycnometer and |
| | (e.g., g/cc | | comparing to the theoretical |
| | or g/cm³) | | density of the individual |
| | | | material components present |
| | | | in the particle. |
| Active | Particle Size | Dynamic | laser particle size distribution |
| Material | Distribution | light | analysis (LPSA) on well- |
| Particle | (e.g., nm or | scattering | dispersed particle suspensions |
| Pop- | μm) | particle size | in one example or by image |
| ulation | | analyzer, | analysis of electron |
| | | scanning | microscopy images, or by |
| | | electron | other suitable techniques. |
| | | microscope | While there are diverse |
| | | | processes of measuring PSDs, |
| | | | laser particle size distribution |
| | | | analysis (LPSA) is quite |
| | | | efficient for some applications. |
| | | | Note that other types of |
| | | | particle size distribution (e.g., |
| | | | by SEM image analysis) could |
| | | | also be utilized (and may even |
| | | | lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D10), a fiftieth- |
| | | | percentile volume-weighted |
| | | | particle size parameter (e.g., |
| | | | abbreviated as D50), a |
| | | | ninetieth-percentile volume- |
| | | | weighted particle size |
| | | | parameter (e.g., abbreviated as |
| | | | D90), and a ninety-ninth- |
| | | | percentile volume-weighted |
| | | | particle size parameter (e.g., |
| | | | abbreviated as D99). |
| Active | Width (e.g., | PSA | Parameters relating to |
| Material | nm) | | characteristic widths of the |
| Particle | | | PSD may be derived from |
| Pop- | | | these particle size parameters, |
| ulation | | | such as D50-D10 (sometimes |
| | | | referred to herein as a left |
| | | | width), D90-D50 (sometimes |
| | | | referred to herein as a right |
| | | | width), and D90-D10 |
| | | | (sometimes referred to herein |
| | | | as a full width). |
| Active | Cumulative | Computed | A cumulative volume fraction, |
| Material | Volume | via LPSA | defined as a cumulative |
| Particle | Fraction | data | volume of the composite |
| Pop- | | | particles with particle sizes of |
| ulation | | | a threshold particle size or |
| | | | less, divided by a total volume |
| | | | of all of the composite |
| | | | particles, may be estimated by |
| | | | LPSA. |
| Active | Com- | Balance | The mass of active materials |
| Material | position | | added to the electrode divided |
| Particle | (e.g., | | by the total mass of the |
| Pop- | wt. %) | | electrode. |
| ulation | | | |
| Active | BET SSA | BET | obtained from the data of |
| Material | (e.g., | Isotherm | nitrogen sorption-desorption at |
| Particle | m²/g) | | cryogenic temperatures, such |
| Pop- | | | as about 77K |
| ulation | | | |
| Elec- | Salt | balance, | Total volume of the solution is |
| trolyte | Con- | volumetric | computed either via the sum of |
| | centration | pipette | the volume of the constituents |
| | (e.g., M or | | (measured by a volumetric |
| | mol. %) | | pipette), or by the mass of the |
| | | | constituents divided by the |
| | | | density. The molar mass of the |
| | | | salt is then used to calculate |
| | | | the total number of moles of |
| | | | salt in the solution. The moles |
| | | | of salt is then divided by the |
| | | | total volume to obtain the |
| | | | solvent concentration in M |
| | | | (mol/L). |
| Elec- | Solvent | balance, | Total volume of the solution is |
| trolyte | Con- | volumetric | computed either via the sum of |
| | centration | pipette | the volume of the constituents |
| | (e.g., M or | | (measured by a volumetric |
| | mol. %) | | pipette), or by the mass of the |
| | | | constituents divided by the |
| | | | density. The molar volume of |
| | | | each solvent is then used to |
| | | | calculate the total number of |
| | | | moles of solvent in the |
| | | | solution. The moles of solvent |
| | | | is then divided by the total |
| | | | volume to obtain the solvent |
| | | | concentration in M (mol/L). |
| Elec- | Com- | Balance | The mass fraction of a material |
| trode | position | | (e.g., active material, active |
| | (e.g., mass | | material particle, binder, etc.) |
| | fraction | | in the electrode is calculated |
| | or wt. | | based on a measured or |
| | %) | | estimated mass of the material |
| | | | and a measured or estimated |
| | | | mass of the electrode, |
| | | | excluding the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be measured |
| | | | before being mixed into a |
| | | | slurry to estimate their mass in |
| | | | a casted electrode. The mass of |
| | | | materials deposited onto the |
| | | | casted electrode may be |
| | | | measured by comparing the |
| | | | weight of the casted electrode |
| | | | before/after the material |
| | | | deposition. |
| Elec- | Areal | balance | A mass fraction of the binder |
| trode | Binder | | in the battery electrode, |
| | Loading | | divided by a product of (1) a |
| | (e.g., | | mass fraction of the active |
| | mg/m²) | | material (e.g., Si-C |
| | | | nanocomposite, etc.) particles |
| | | | in the battery electrode, and |
| | | | (2) a Brunauer-Emmett-Teller |
| | | | (BET) specific surface area of |
| | | | the active material particle |
| | | | population. |
| Elec- | Capacity | Calculated | Measure the mass (wt.) of |
| trode | Attrib- | | active material in the |
| | utable | | electrode, and calculate |
| | to | | electrode capacity based on the |
| | Active | | known theoretical capacity of |
| | Material | | the active material. For |
| | (active | | example, the average wt. % of |
| | material | | active material in each active |
| | capacity | | material particle may be |
| | fraction) | | measured and used to calculate |
| | | | the mass of the active material |
| | | | based on the mass of the active |
| | | | material particles before being |
| | | | mixed in the slurry. This |
| | | | process may be repeated if the |
| | | | electrode includes two or more |
| | | | active materials to calculate |
| | | | the relative capacity attribution |
| | | | for each active material in the |
| | | | electrode. |
| Elec- | Capacity | Potentiostat | Determine the average specific |
| trode | Attrib- | and | capacity (mAh/g) of active |
| | utable | balance | material particles. For |
| | to | | example, the average specific |
| | Active | | capacity may be estimated |
| | Material | | from the average wt. % of |
| | Particles | | active material(s) in each |
| | (active | | particle and its associated |
| | material | | known theoretical |
| | particle | | capacity(ies). Then, measure |
| | capacity | | the mass (wt.) of active |
| | fraction) | | material particles in the |
| | | | electrode before being mixed |
| | | | in slurry, which may be used |
| | | | to calculate the capacity |
| | | | attributable to that active |
| | | | material. This process may be |
| | | | repeated if the electrode |
| | | | includes two or more active |
| | | | material particle types to |
| | | | calculate the relative capacity |
| | | | attribution for each active |
| | | | material particle type in the |
| | | | electrode. |
| Elec- | Mass of | balance | The average wt. % of active |
| trode | Active | | material in each active |
| | Material in | | material particle may be |
| | Electrode | | measured, and used to |
| | | | calculate the mass of the active |
| | | | material based on the mass of |
| | | | the active material particles |
| | | | before being mixed in slurry. |
| Elec- | Mass of | balance | Measure the active material |
| trode | Active | | particle before the active |
| | Material | | material particle type is mixed |
| | Particle in | | in the slurry. |
| | Electrode | | |
| Elec- | Areal | Potentiostat | Areal capacity loading is the |
| trode | Capacity | and | weight of the coated active |
| | Loading | balance | material per unit area (g/cm²) |
| | (e.g., | | multiplied by the gravimetric |
| | mAh/cm²) | | capacity of the active material |
| | | | (not the electrode, but the |
| | | | active material itself with zero |
| | | | binder and zero electrolyte; |
| | | | mAh/g). |
| Elec- | Coulombic | Potentiostat | The change in charge inserted |
| trode | Efficiency | | (or extracted) to an electrode |
| | | | divided by the charge |
| | | | extracted (or inserted) from the |
| | | | electrode during a complete |
| | | | electrochemical cycle within |
| | | | given voltage limits. Because |
| | | | the direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an |
| | | | electrochemical cell consisting |
| | | | of a cathode or anode material |
| | | | of interest as the working |
| | | | electrode and a lithium metal |
| | | | foil which functions as both |
| | | | the counter and reference |
| | | | electrode. Then, charge is |
| | | | either inserted or removed |
| | | | from the material of interest |
| | | | until the cell voltage reaches |
| | | | an appropriate limit. Then, the |
| | | | process is reversed until a |
| | | | second voltage limit is |
| | | | reached, and the charge passed |
| | | | in both steps is used to |
| | | | calculate the Coulombic |
| | | | Efficiency, as described above. |
| Battery | Rate | Potentiostat | This is the time it takes to |
| Cell | Per- | | charge or discharge a battery |
| | formance | | between a given state of |
| | | | charge. It is measured by |
| | | | charging or discharging a |
| | | | battery and measuring the time |
| | | | until a specified amount of |
| | | | charge is passed, or until the |
| | | | battery operating voltage |
| | | | reaches a specified value. |
| Battery | Cell | Potentiostat | A battery consisting of a |
| Cell | Discharge | | relevant anode and cathode is |
| | Voltage | | charged and discharged within |
| | (e.g., V) | | certain voltage limits and the |
| | | | charge-weighted cell voltage |
| | | | during discharge is computed. |
| Battery | Operating | Potentiostat | Average temperature of |
| Cell | Temper- | and | battery cell as measured at the |
| | ature | thermo- | positive/negative terminal/ |
| | | couples | cell shaft/etc. while |
| | | | charging/discharging, or at a |
| | | | certain voltage level, or while |
| | | | a load is applied, etc. |
| Battery | Anode | Potentiostat | An electrode containing an |
| Half- | Discharge | | active anode material (or a |
| Cell | (de- | | mixture of active materials) of |
| | lithiation) | | interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery | Cathode | Potentiostat | An electrode containing an |
| Half- | Discharge | | active cathode material (or a |
| Cell | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery | Volumetric | Potentiostat | The VED is calculated by first |
| Cell | Energy | | calculating the energy per unit |
| | Density | | area of the battery, and then |
| | (VED) | | dividing the energy per unit |
| | | | area by the sum of the |
| | | | illustrative anode, cathode, |
| | | | separator, and current collector |
| | | | thicknesses |
| Battery | Internal | Potentiostat | The internal resistance (also |
| Cell | Resistance | | known as impedance in many |
| | (imped- | | contexts) is measured by |
| | ance) | | applying small pulses of |
| | | | current to the battery cell and |
| | | | recording the instantaneous |
| | | | change in cell voltage. |

In some embodiments described below, certain parameters (e.g., temperature, state-of-charge (SOC), etc.) are defined in terms of relative terminology such as low, reduced, high, increased, elevated, and so on, With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

Reference below is made to various battery electrode compositions. Such battery electrode compositions may be in the form of a “dry” powder (e.g., before being mixed into or suspended in a slurry), in the slurry itself (e.g., in a suspended state), or in a casted electrode (e.g., casted onto and/or into a current collector to form an electrode, bound together with a suitable binder, dried, and optionally coated and/or calendered).

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur(S), to name a few and where a total mass of the Si and the C atoms may contribute from about 75 wt. % to about 100 wt. % of the total mass of the composite particles), it will be appreciated that various aspects may be applicable to other types of high-capacity silicon-comprising anode active materials (including but not limited to, for example, various silicon-comprising or silicon oxide-comprising or silicon nitride-comprising or silicon oxy-nitride comprising or silicon phosphide-comprising particles or particles comprising a mixture or alloy or other combinations of such active materials, various other types of Si-comprising composites including, but not limited to core-shell or hierarchical or nanocomposite particles, etc.).

While the description below may describe certain examples in the context of some specific alloying-type and conversion-type chemistries of anode and cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

In one or more embodiments of the present disclosure, a preferred anode for a battery cell may comprise a mixture of Si—C nanocomposite (e.g., particles) and graphite (particles) as the anode active material, a so-called blended anode. In addition to the anode active material particles, an anode may comprise inactive material, such as binder(s) (e.g., polymer binder) and other functional additives (e.g., surfactants, electrically conductive additives). In some implementations, the anode active material may be in a range of about 90 wt. % to about 98 wt. % of the anode. For example, the anode active material particles may be about 95.5 wt. % of the anode. In some implementations, blended anodes may comprise Si—C nanocomposites (e.g., particles) ranging from about 7 wt. % to about 75 wt. % of the anode and the graphite (e.g., particles) making up the remainder of the mass (the weight) of the anode active material particles. In some implementations in which the anode active material particles are about 95.5 wt. % of the blended anode, the blended anode (including active material particles and inactive material) may comprise about 7 wt. % of Si—C nanocomposite (e.g., particles) and about 88.5 wt. % of graphite particles. In some implementations in which the anode active material particles are about 95.5 wt. % of the blended anode, the blended anode (including active material particles and inactive material) may comprise about 19 wt. % of Si—C nanocomposite (e.g., particles) and about 76.5 wt. % of graphite particles. In some implementations in which the anode active material particles are about 95.5 wt. % of the blended anode, the blended anode (including active material particles and inactive material) may comprise about 35 wt. % of Si—C nanocomposite (e.g., particles) and about 60.5 wt. % of graphite particles. In some implementations in which the anode active material particles are about 94.5 wt. % of the blended anode, the blended anode (including active material particles and inactive material) may comprise about 50 wt. % of Si—C nanocomposite (e.g., particles) and about 44.5 wt. % of graphite particles. In some implementations in which the anode active material particles are about 92.5 wt. % of the blended anode, the blended anode (including active material particles and inactive material) may comprise about 69.4 wt. % of Si—C nanocomposite (e.g., particles) and about 23.1 wt. % of graphite particles. In some designs, a higher fraction of Si—C composite particles in the blended anode may benefit from a higher fraction of inactive material to attain superior cycle stability and other performance characteristics.

While the descriptions below may also describe certain examples of the blended anode formulations expressed as mass (wt. %) of Si—C nanocomposite (e.g., particles), it will be appreciated that various aspects of this disclosure may be applicable to blended anode formulations expressed as wt. % of Si in the anode. In some implementations, a blended anode composition of about 7 wt. % of Si—C nanocomposite (e.g., particles) may correspond, for example, to about 3-3.5 wt. % of Si in the blended anode. In some implementations, a blended anode composition of about 19 wt. % of Si—C nanocomposite corresponds to about 8-9.5 wt. % of Si in the blended anode. In some implementations, a blended anode composition of about 35 wt. % of Si—C nanocomposite (e.g., particles) corresponds to about 15-18 wt. % of Si in the blended anode. In some implementations, a blended anode composition of about 50 wt. % of Si—C nanocomposite (e.g., particles) corresponds to about 21-30 wt. % of Si in the blended anode. In respective implementations, blended anodes may be obtained in which the mass (weight) of the silicon is in a range of about 3 wt. % to about 30 wt. % of a total mass of the anode.

While the descriptions below may also describe certain examples of the blended anode formulations expressed as mass (wt. %) of Si—C nanocomposite (e.g., particles), it will be appreciated that various aspects of this disclosure may be applicable to blended anode formulations attributing a fraction (e.g., %) of the total capacity of the blended anode to the capacity of the Si. In some implementations, about 25% of the total capacity of the blended anode is obtained from the Si—C nanocomposite (e.g., particles) in a blended anode composition of about 7 wt. % of Si—C nanocomposite (e.g., particles). In some other implementations, about 50% of the total capacity of the blended anode is obtained from the Si—C nanocomposite (e.g., particles) in a blended anode composition of about 19 wt. % of Si—C nanocomposite (e.g., particles). In some other implementations, about 70% of the total capacity of the blended anode is obtained from the Si—C nanocomposite (e.g., particles) in a blended anode composition of about 35 wt. % of Si—C nanocomposite (e.g., particles). In some other implementations, about 80% of the total capacity of the blended anode is obtained from the Si—C nanocomposite (e.g., particles) in a blended anode composition of about 50 wt. % of Si—C nanocomposite (e.g., particles).

While the description below may describe certain examples of suitable intercalation-type graphites to be used in combination with Si—C nanocomposite (e.g., particles) in a blend, it will be appreciated that various aspects of this disclosure may be applicable to soft-type synthesis graphite (or soft carbon, broadly), hard-type synthesis graphite (or hard carbon, broadly), and natural graphite (which may, for example, be pitch carbon coated); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit Brunauer-Emmett-Teller (BET) specific surface area of about 1 to about 4 m²/g; including but not limited to those which exhibit lithiation efficiency of about 90% and more; including but not limited to those which exhibit particle sizes from about 8 μm to about 18 μm; including but not limited to those which exhibit densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si—C composites or other active particles); including but not limited to those which are coated and comprise coatings with coating thickness to appreciably improve compression and springing during cycling.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as Li_{1.211}Mo_{0.467}Cr_{0.3}O₂, Li_{1.3}Mn_{0.4}Nb_{0.3}O₂, Li_{1.2} Mn_{0.4}Ti_{0.4}O₂, Li_{1.2}Mn_{0.8}O₂, Li_{1.2}Mn_{0.7}W_{0.07}O₂, Li_{1.2}Mn_{0.8}O_{1.95}F_{0.1}, Li_{1.2}Mn_{0.75}Zr_{0.05}O_{1.95}F0.1, Li_{1.2}Mn_{0.7}Zr_{0.05}W_{0.035}O_{1.95}F_{0.1}, Li_{1.2}Ni_{0.333}Ti_{0.333}Mo_{0.133}O₂ and many others), various high capacity Li-ion based materials with partial substitution of oxygen for fluorine or iodine (e.g., rocksalt Li₂Mn_{2/3}Nb_{1/3}O₂F, Li₂Mn_{1/2}Ti_{1/2}O₂F, Li_{1.5} Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode or anode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

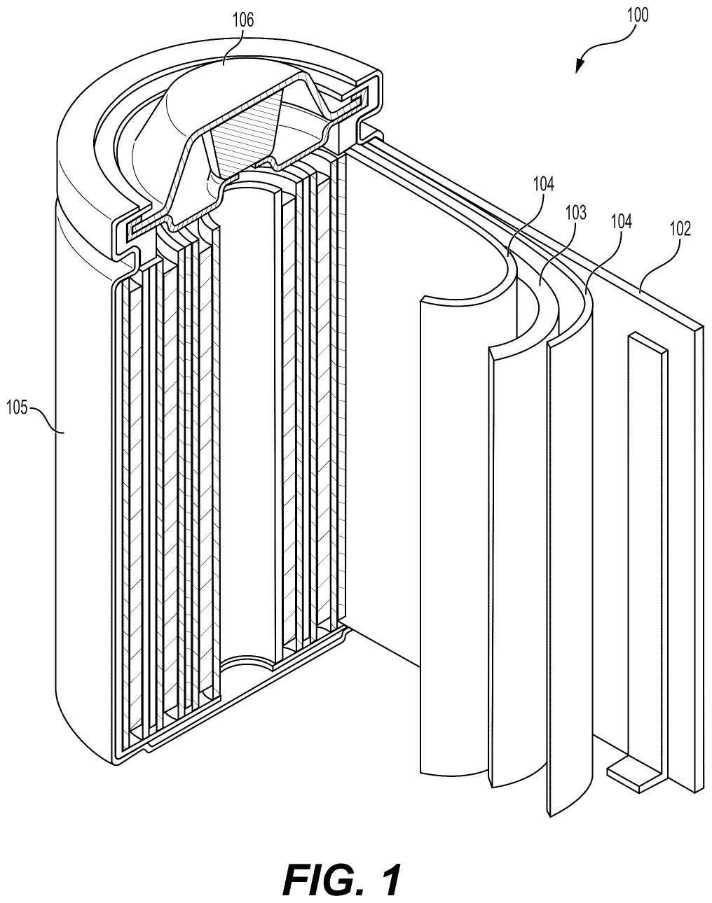

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on or in the anode current collector and the cathode is disposed on or in the cathode current collector.

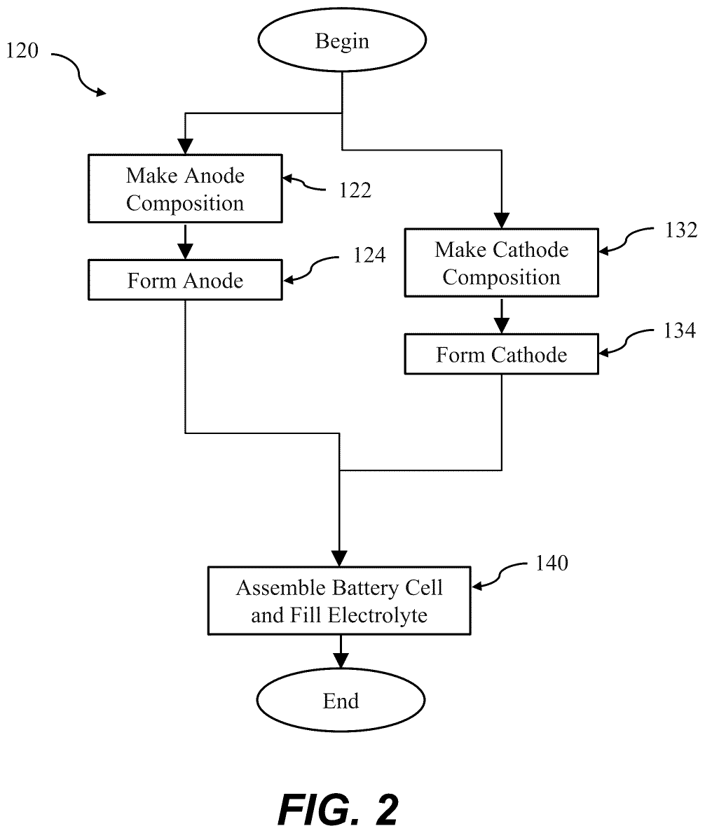

FIG. 2 shows a flow diagram of a process 120 for making a Li-ion battery, such as the example battery 100 of FIG. 1. In the example shown, process 120 includes operations 122, 124, 132, 134, and 140. The flow diagram includes an anode branch (left branch) that includes operations 122 and 124, and a cathode branch (right branch) includes operations 132 and 134. At operation 122, anode particles (e.g., conventional anode particles or core-shell anode particles or composite anode particles, including but not limited to Si-comprising composite particles whereby Si-comprising active material is deposited within pore(s) of a particle core) are made, and at operation 124, an anode is formed. Similarly, at operation 132, cathode particles (e.g., conventional cathode particles or core-shell cathode particles or composite cathode particles, including but not limited to conversion-type cathode active material-comprising composite particles whereby conversion-type cathode active material active material is deposited within pore(s) of a particle core) are made, and at operation 134, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto a metal foil (e.g., Cu or Cu-alloy foil for most anodes and A1 or A1-alloy foil for most cathodes); and (iii) drying the casted electrodes to completely evaporate the solvent. In some implementations, the stage (iii) may also include densifying the battery electrode to a desired value. Note that a metal mesh, metal foam or very rough metal foil (e.g., comprising metal nanowires or metal nanosheets on its surface) may be used in some designs (e.g., for higher areal capacity loadings or for achieving faster charge, etc.). Also note that a metal coated thin polymer sheets may also be used in some designs (e.g., to achieve improved safety or lower current collector weight, etc.). Also note that a porous metal foil or composite (e.g., nanocomposite) metal foils may be used in some designs (e.g., for improved properties, lower weight, etc.).

Operation 124 includes making an anode electrode, with the anode electrode including the anode particles made at operation 122. For example, this operation 124 can include (1) making an anode slurry that includes the anode particles (e.g., from operation 122) and other anode slurry components and (2) casting the anode slurry on an anode current collector (e.g., copper foil or copper-alloy foil current collector). In some designs, this stage may often include evaporating the slurry solvent and/or densifying the battery electrode to a desired value. For example, other anode slurry components can include: other electrochemically anode active materials (e.g., natural or synthetic graphite, soft carbon or hard carbon), electrically conductive additives (e.g., carbon nanotubes or carbon black or branched carbon or carbon nanofibers or graphite flakes or exfoliated graphite or graphene (e.g., single-walled graphene, multi-walled graphene) or graphene oxide (e.g., single-walled graphene oxide, multi-walled graphene oxide) or soft graphite or their various combinations, to name a few), binders (e.g., polymer binders), and solvents (e.g., water or a suitable organic solvent).

Operation 134 includes making a cathode electrode, with the cathode electrode including the cathode particles made at operation 132. For example, this operation 134 can include (1) making a cathode slurry that includes the cathode particles (e.g., from operation 132) and other cathode slurry components and (2) casting the cathode slurry on a cathode current collector (e.g., aluminum foil or aluminum-alloy foil current collector). In some designs, this stage may often include evaporating the slurry solvent and/or densifying the battery electrode to a desired value. For example, other cathode slurry components can include: other electrochemically cathode active materials, electrically conductive additives (e.g., carbon nanotubes or carbon black or branched carbon or carbon nanofibers or graphite flakes or graphene (e.g., single-walled graphene, multi-walled graphene) or graphene oxide (e.g., single-walled graphene oxide, multi-walled graphene oxide) or soft graphite or their various combinations, to name a few), binders (e.g., polymer binders), and solvents (e.g., water or a suitable organic solvent).

At operation 140, the Li-ion rechargeable battery cell is assembled from at least the anode electrode and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator may be used to maintain a space between the anode and the cathode electrodes.

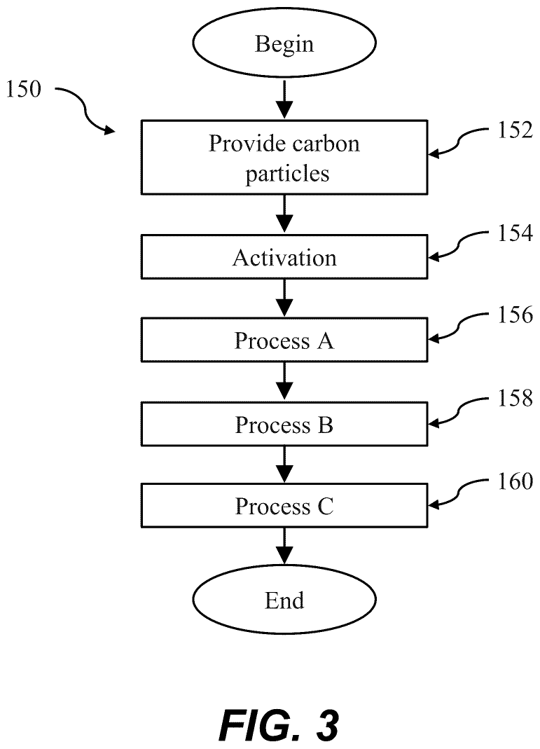

FIG. 3 is a flow diagram of a process 150 of making anode particles and illustrates operation 122 in greater detail. Process 150 includes operations 152, 154, 156, 158, and 160. In some designs, the processes and systems as described herein may be particularly useful when implemented as part of operation 122 and/or operation 132. In some implementations, electrode particles are made using porous carbon or porous carbon-containing particles, with nanostructured or nano-sized active material particles (e.g., with average diameter or linear dimensions in the range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques) being formed in the pores of the porous carbon or porous carbon-containing particles. In the case of anode particles for use in Li-ion batteries, the active material particles may be silicon-comprising particles.

At operation 152, carbon particles are provided. In some designs, carbon particles may be obtained from pyrolysis or carbonization (e.g., by heat treatment or hydrothermal treatment) of a suitable precursor particle, such as a polymer particle or a biomass-derived particle. In some designs, carbon particles may be obtained from carbon-comprising inorganic precursor particles (e.g., carbides or oxy-carbides, etc.).

In some designs, inorganic templates (including, but not limited to various oxides or hydroxides or oxyhydroxides of various metals and semi-metals—e.g., Zn, Mg, Si, A1, Ti, Ca, Mg, Sc, etc. and their various combinations) or soft (organic) templates may be used for the formation of porous carbon particles.

In some designs, it may be preferable that the porosity of the carbon or carbon-containing particles (e.g., specific surface area and specific pore volume) be quite high before the formation of the nanostructured or nano-sized active material particles therein. In some implementations, it is preferable that the carbon or carbon-containing particles exhibit a Brunauer-Emmett-Teller (BET) specific surface area (e.g., obtained from the data of nitrogen sorption-desorption at cryogenic temperatures, such as about 77K) of about 500 m²/g or more, before formation of the active material particles therein. In some implementations, it is preferable that the carbon particles exhibit a BET specific surface area in a range of about 500 m²/g to about 4500 m²/g or about 4800 m²/g (in some designs, from around 500 to about 1000 m²/g; in other designs, from around 1000 to about 2000 m²/g; in other designs, from around 2000 to about 3000 m²/g; in other designs, from around 3000 to about 3800 m²/g; in yet other designs, from around 3800 to about 4800 m²/g), before formation of the active material particles therein and after the activation at 154. In some implementations, it is preferable that the carbon particles exhibit a total micro- and meso-pore volume (not counting macropores, above 50 nm) in a range of about 0.5 cc/g to about 5 cc/g (in some designs, from around 0.5 to about 1 cc/g; in other designs, from around 1 to about 2 cc/g; in other designs, from around 2 to about 3.5 cc/g; in other designs, from around 3.5 to about 5 cc/g), before formation of the active material particles therein and after the activation at 154. In some designs, such high surface areas can be obtained by carrying out physical or chemical activation of carbon or carbon-containing precursor particles, or by rapid annealing of carbon or carbon-containing precursor particles or by using temporary template materials or by other known suitable means. In some cases, the precursor particles themselves may be highly porous (e.g., aerogel particles). Nevertheless, in some designs, it may be preferable to produce or enhance porosity in carbon or carbon precursor particles (e.g., by carrying out activation on the carbon or carbon-containing particles or by leaching out non-carbon components of carbon-containing particles) before formation of the active material particles therein and after the activation at 154 to tune the porosity characteristics. Accordingly, operation 154 includes carrying out a porosity enhancing (e.g., an activation) process on the carbon particles (e.g., from operation 152).

After the activation operation (operation 154), other process operations, such as process A at operation 156, process B at operation 158, and process C at operation 160, are carried out. In the example shown, there are three process operations after porosity enhancing (e.g., an activation) process (operation 154) but in other implementations there may be less than or more than three process operations after activation. For illustration, process 150 is described with respect to the formation of certain electrode (e.g., anode) particles. The concepts of process 150 including porosity enhancing (e.g., an activation) of carbon particles can be applied to other anode particles or with cathode particles that require activation of carbon particles.

In the example illustrated in FIG. 3, nanostructured or nano-sized silicon (Si) or silicon oxide (SiOₓ) or silicon nitride (SiN_{y}) or silicon oxy-nitride (SiOₓN_{y}) or silicon phosphide (SiP_{z}) particles (0<x<2; 0<y<1.3; 0<z<1) or their various combinations, alloys and mixtures are formed within the pores (and/or on the surface) of porous carbon or porous carbon-containing particles. For example, process A (operation 156) includes the formation of silicon-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles can be accomplished by solution-based or vapor-based deposition processes, in some examples, or by other suitable means. For brevity, the particles upon completion of process A are sometimes referred to as silicon-carbon composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

In the example shown, process B is carried out at operation 158. For example, process B includes the formation of a protective coating on and in the silicon-carbon composite particles (from operation 156). In some designs, the suitable average thickness of the protective coating may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm). In some designs, the true density of the protective coating may range from about 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc).

In some designs, the protective coating may comprise or be based on electronically conductive material such as carbon. In some designs, such a carbon coating may be doped (e.g., with B, P, N, O and/or other elements). In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). In some designs, the protective coating may be largely impermeable to electrolyte solvent.

During operation of a Li-ion battery cell (e.g., 100 in FIG. 1), the protective coating may prevent direct contact between the silicon nanoparticles and an electrolyte solvent composition. In some designs, direct contact between the electrolyte solvent composition and the silicon nanoparticles may undesirably accelerate degradation of the Li-ion battery cell, in some designs.

In the example shown, process C is carried out at operation 160. For example, process C includes making changes to the particle size distribution (PSD). Process C may include carrying out comminution on the protected silicon-carbon composite particles (from operation 158). Comminution may be carried out when the particle sizes are larger (on average) than a final desired (e.g., for a slurry and electrode processing) particle size distribution. Various processes of carrying out comminution are known in the art. For example, the comminution can be carried out by one or more of: ball milling, jet milling, attrition milling, pin milling, and hammer milling. In some implementations, it may be preferable to carry out particle size selection during process operation C. In some cases, process C can include particle size selection (e.g., by sieving or by screening or by centrifugation or by other aerodynamic size classification or by other means) in addition to comminution (e.g., particle size selection after comminution). In some cases, process C can include particle size selection without comminution. For example, it may be preferable to retain some of the larger particle sizes and discard the finer particle sizes. The particle size selection may be carried out by any one of suitable processes known to those skilled in the art, such as screening, sieving, and aerodynamic size classification.

The foregoing process operation C (160) includes examples, such as comminution and particle size selection, of making changes to a particle size distribution (PSD) of a population of particles. In some cases, it may be preferable to employ additional or alternative processes for changing or adjusting a PSD, such as mixing two or more populations of particles wherein each of the populations has a PSD different from others of the populations. For example, particle populations of different PSDs may be obtained (e.g., obtained from a supplier or made to different PSDs including employing the aforementioned processes of comminution and/or particle size selection under different processing conditions).

Upon completion of the operations in process 150 (e.g., operations 152, 154, 156, 158, 160), the composite particles may be characterized by a Brunauer-Emmett-Teller (BET) specific surface area (SSA) (e.g., obtained from the data of nitrogen sorption-desorption at cryogenic temperatures, such as about 77K). In some embodiments, the BET-SSA of the composite particles is in a range of about 1 m²/g to about 50 m²/g (in some designs, from about 1.5 m²/g to about 14.0 m²/g; in other designs, from about 2.3 m²/g to about 8.0 m²/g; in yet other designs, from about 1 to about 3 m²/g; in yet other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

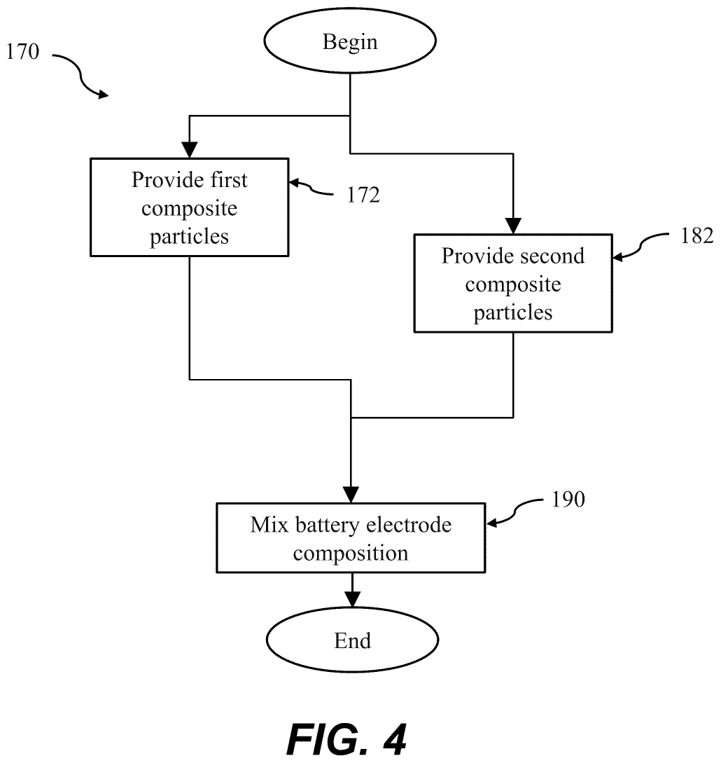

FIG. 4 shows a flow diagram of a process 170 for making a battery electrode composition in accordance with one or more embodiments. Process 170 includes operations 172, 182, and 190. Operations 172 and 182 may be carried out concurrently. Operation 172 comprises providing a first population of first composite (e.g., nanocomposite) particles and operation 182 comprises providing a second population of second composite (e.g., nanocomposite) particles. In some implementations, each of the first composite particles comprise silicon and carbon (e.g., Si—C composite particles). In some implementations, each of the second composite particles comprise silicon and carbon (e.g., Si—C composite particles). Each of the first and second populations of composite particles may comprise composite particles that constitute any of the foregoing battery electrode compositions. At each of operations 172 and 182, each respective population of particles may be manufactured according to the process operations outlined in FIG. 3 (e.g., including one or more of operations 152, 154, 156, 158, and 160). At each of operations 172 and 182, each respective population of particles may undergo changes to its PSD such as comminution and/or particle size selection (e.g., as described with reference to operation 160).

The particle size distribution (PSD) that characterizes a particle population may be determined by laser particle size distribution analysis (LPSA), image analysis of electron microscopy images, or other suitable techniques. The particle size distribution (PSD) may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), D₉₀−D₁₀ (sometimes referred to herein as a full width), and (D₉₀−D₁₀)/D₅₀ (sometimes referred to herein as a span).

The first population is characterized by a first particle size distribution (PSD^{L}) as determined by LPSA and the second population is characterized by a second particle size distribution (PSD^{S}) as determined by LPSA. In some implementations, the first population (the first composite particles) and the second population (the second composite particles) are selected such that the first and second particle size distributions are different. In some implementations, the first population and the second population are selected such that the median particle size of the first population (e.g., fiftieth-percentile volume-weighted particle size parameter, abbreviated as D₅₀^{L}) is greater than median particle size of the second population (e.g., fiftieth-percentile volume-weighted particle size parameter, abbreviated as D₅₀^{S}). In such cases, the first composite particles and the second composite particles may be referred to as larger composite particles and smaller composite particles, respectively. In some implementations, a size ratio α may be defined as

$$α = \frac{{D}_{50}^{L}}{{D}_{50}^{S}} ,$$

such that α>1.

Operation 190 (FIG. 4) comprises mixing at least the first population and the second population to form the battery electrode composition. In some implementations, the first and second populations are mixed in accordance with a population mass fraction. Herein, the population mass fraction is defined as a mass of the first population divided by a sum of the mass of the first population and a mass of the second population. Accordingly, a population mass fraction of exactly 0.00 corresponds to a battery electrode composition comprising second composite particles (e.g., smaller composite particles) but no first composite particles (e.g., larger composite particles). A population mass fraction of exactly 1.00 corresponds to a battery electrode composition comprising first composite particles (e.g., larger composite particles) but no second composite particles (e.g., smaller composite particles).

In the examples shown, polymer particles were synthesized following a radical chain-growth polymerization of an initiator and a monomer. Particle size was modified by modulating conditions such as initiator and monomer concentrations, reaction temperature, residence time, and surfactant concentration. The synthesized polymer particles were then carbonized at elevated temperatures (e.g., in a range of about 400 to about 900° C.), resulting in carbon particles (operation 152). Subsequently, composite particles comprising silicon and carbon (nanocomposite particles) were prepared according to the remaining operations outlined in process 150 (operations 154, 156, 158, and 160). Composite particle populations of respective particle size distributions (e.g., various D₅₀ values) were prepared. In some implementations, two populations of composite particles (e.g., a first population with a first D₅₀ and a second population with a second D₅₀) were prepared and used as parent populations to mix at various mass fractions to obtain resultant populations. In other implementations, more than two populations of composite particles may be used as parent populations to mix at various mass fractions to obtain resultant populations.

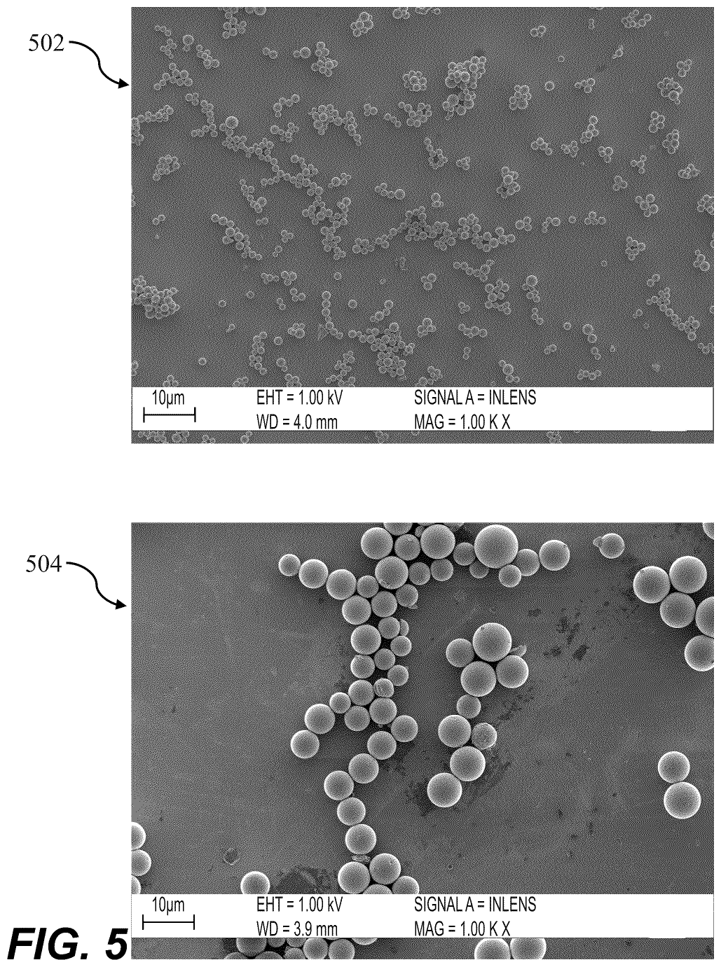

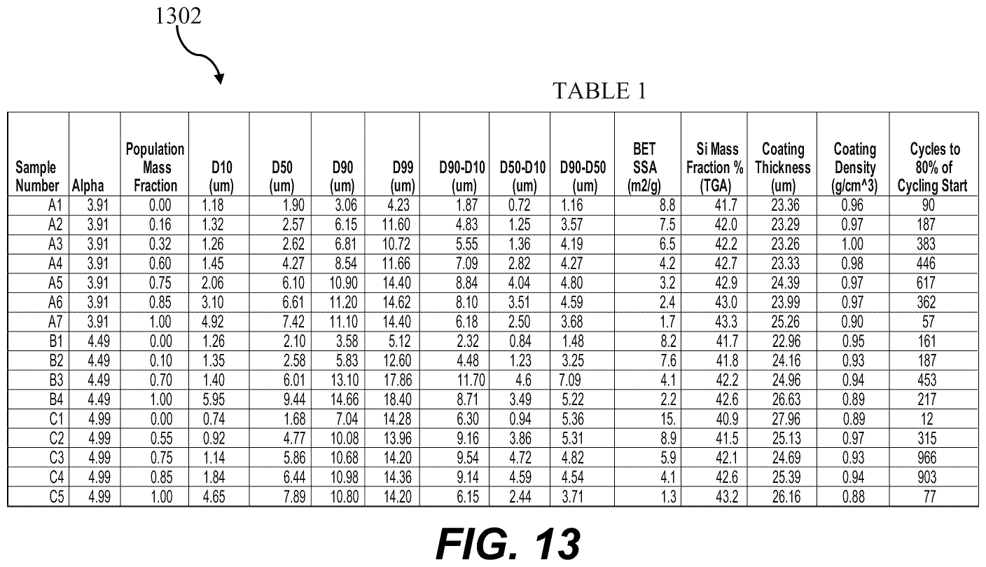

Scanning electron microscope (SEM) images of illustrative example spheroidal composite particles (or their agglomerates) are shown in FIGS. 5, 6, 7, 8, 9, and 10. Herein, the term “spheroidal” is employed to refer to a round shape that is near-spherical or spherical, as exemplified in the images of FIGS. 5-10. Also, reference below to various samples denoted as samples A1-A7, B1-B4 and C1-C5 corresponds to the samples as defined in Table 1302 of FIG. 13. FIG. 5 shows an SEM image 502 of smaller composite particles (taken from population sample A1) and an SEM image 504 of larger composite particles (taken from population sample A7). For example, the preparing of population sample A1 corresponds to operation 182, and the preparing of population sample A7 corresponds to operation 172. Population samples A1 (D₅₀≈1.90 μm) and A7 (D₅₀≈7.42 μm) are related to each other by size ratio α of about 3.91. In the examples shown, the composite particles are round and may be spheroidal or substantially spherical.

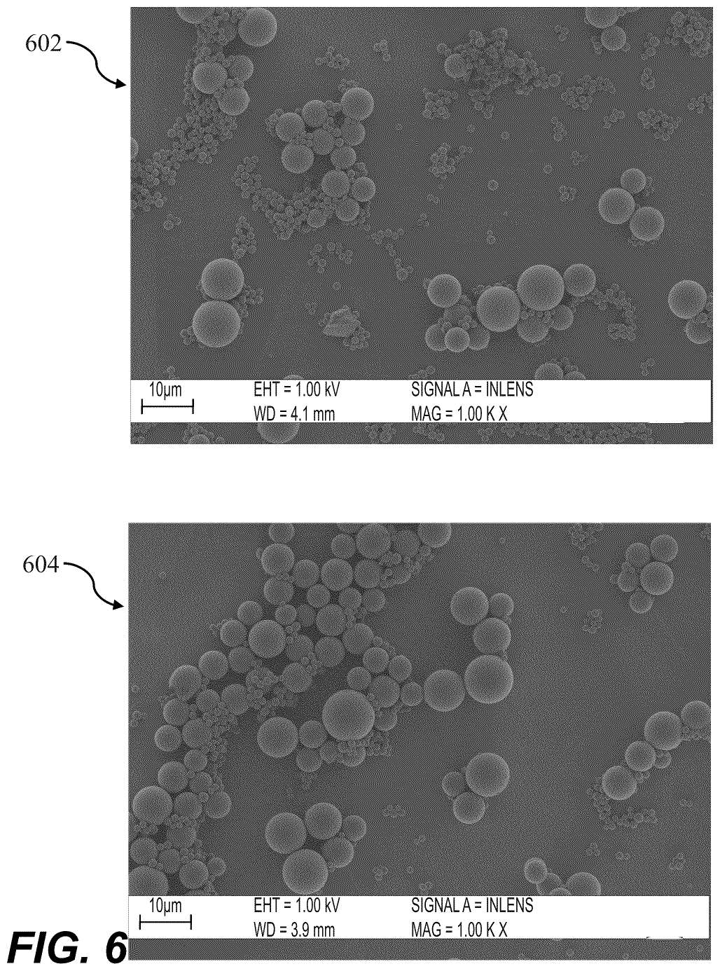

Mixtures of composite particles may be obtained by mixing population samples A1 and A7 at respective population mass fractions. FIG. 6 shows SEM images 602, 604 of composite particles. SEM image 602 shows composite particles taken from population sample A4 obtained by mixing population samples A1 and A7 at a population mass fraction of about 0.60. SEM image 604 shows composite particles taken from population sample A5 obtained by mixing population samples A1 and A7 at a population mass fraction of about 0.75. In the examples shown, the composite particles are round and may be spheroidal or substantially spherical. While not illustrated, other mixtures of composite particles were also obtained, including population sample A2 obtained by mixing population samples A1 and A7 at a population mass fraction of about 0.16, population sample A3 obtained by mixing population samples A1 and A7 at a population mass fraction of about 0.32, and population sample A6 obtained by mixing population samples A1 and A7 at a mass fraction of about 0.85.

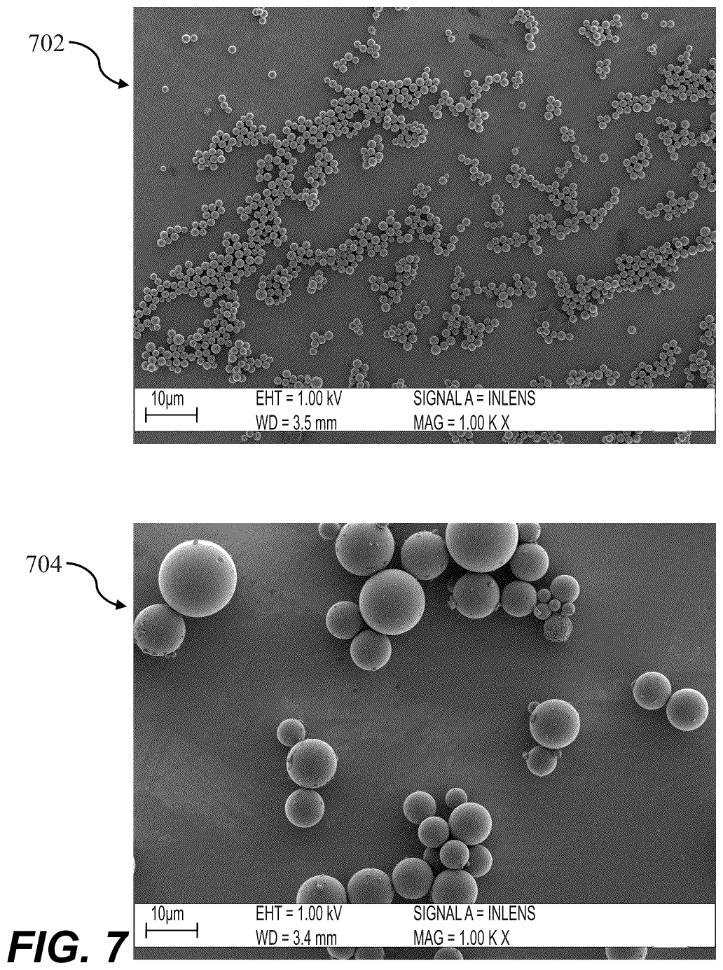

FIG. 7 shows an SEM image 702 of smaller composite particles (taken from population sample B1) and an SEM image 704 of larger composite particles (taken from population sample B4). For example, the preparing of population sample B1 corresponds to operation 182, and the preparing of population sample B4 corresponds to operation 172. Population samples B1 (D₅₀≈2.10 μm) and B4 (D₅₀≈9.44 μm) are related to each other by size ratio α of about 4.49. In the examples shown, the composite particles are round and may be spheroidal or substantially spherical.

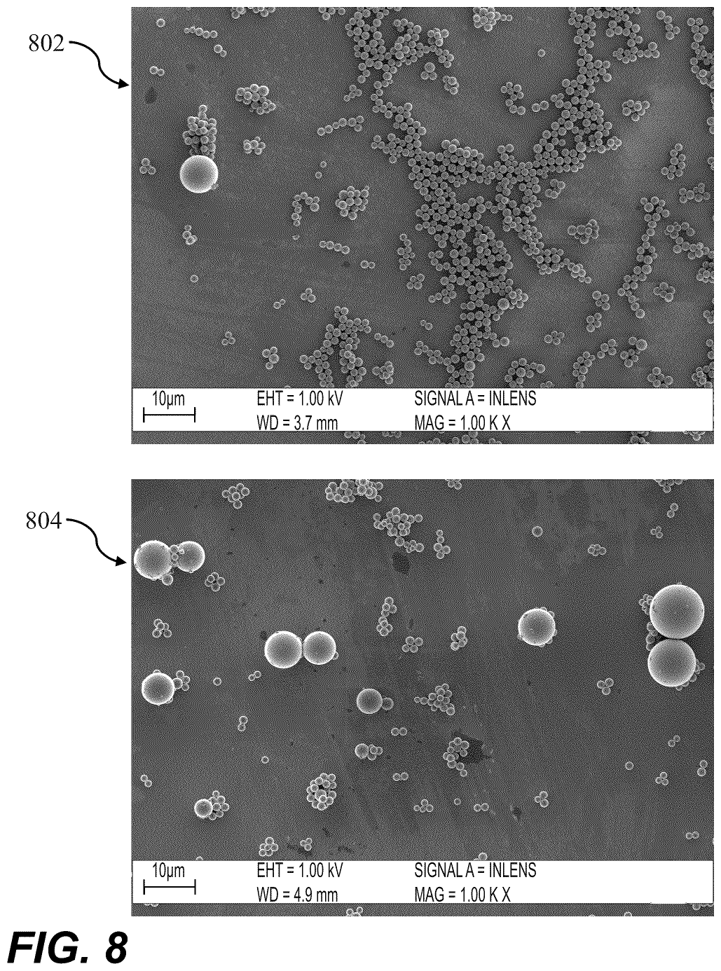

Mixtures of composite particles may be obtained by mixing population samples B1 and B4 at respective population mass fractions. FIG. 8 shows SEM images 802, 804 of spheroidal composite particles. SEM image 802 shows composite particles taken from population sample B2 obtained by mixing population samples B1 and B4 at a population mass fraction of about 0.10. SEM image 804 shows composite particles taken from population sample B3 obtained by mixing population samples B1 and B4 at a population mass fraction of about 0.75. In the examples shown, the composite particles are round and may be spheroidal or substantially spherical.

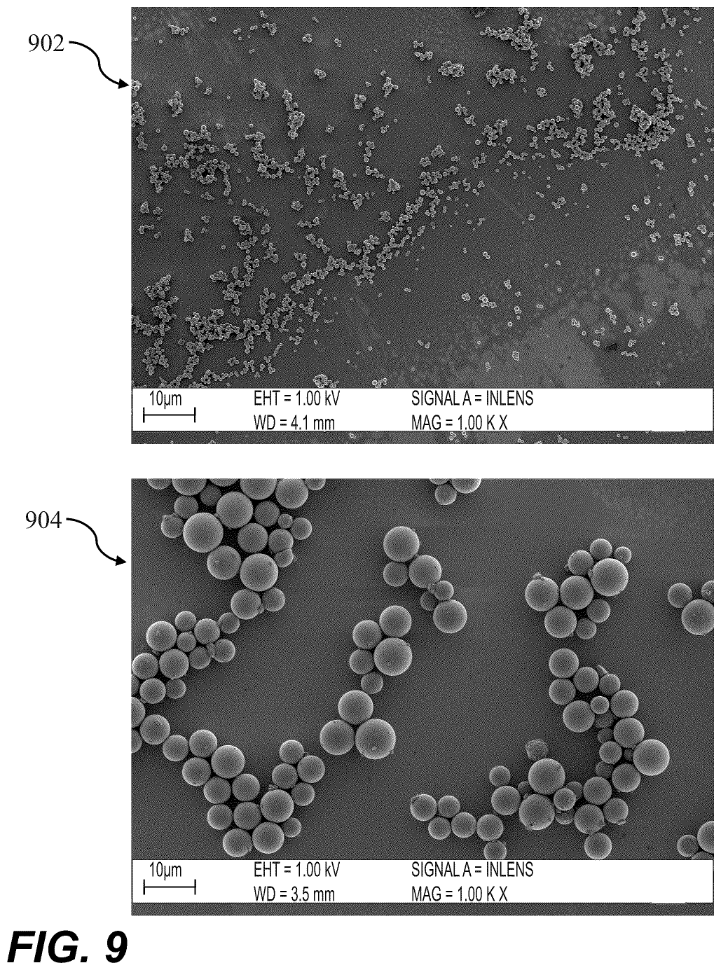

FIG. 9 shows an SEM image 902 of smaller composite particles (taken from population sample C1) and an SEM image 904 of larger composite particles (taken from population sample C5). For example, the preparing of population sample C1 corresponds to operation 182, and the preparing of population sample C5 corresponds to operation 172. Population samples C1 (D₅₀≈1.68 μm) and C5 (D₅₀≈7.89 μm) are related to each other by size ratio α of about 4.99. In the examples shown, the composite particles are round and may be spheroidal or substantially spherical. Herein, the particle populations that are mixed to form mixtures may be referred to herein as “parent” populations (e.g., A1, A7, B1, B4, C1, and C5).

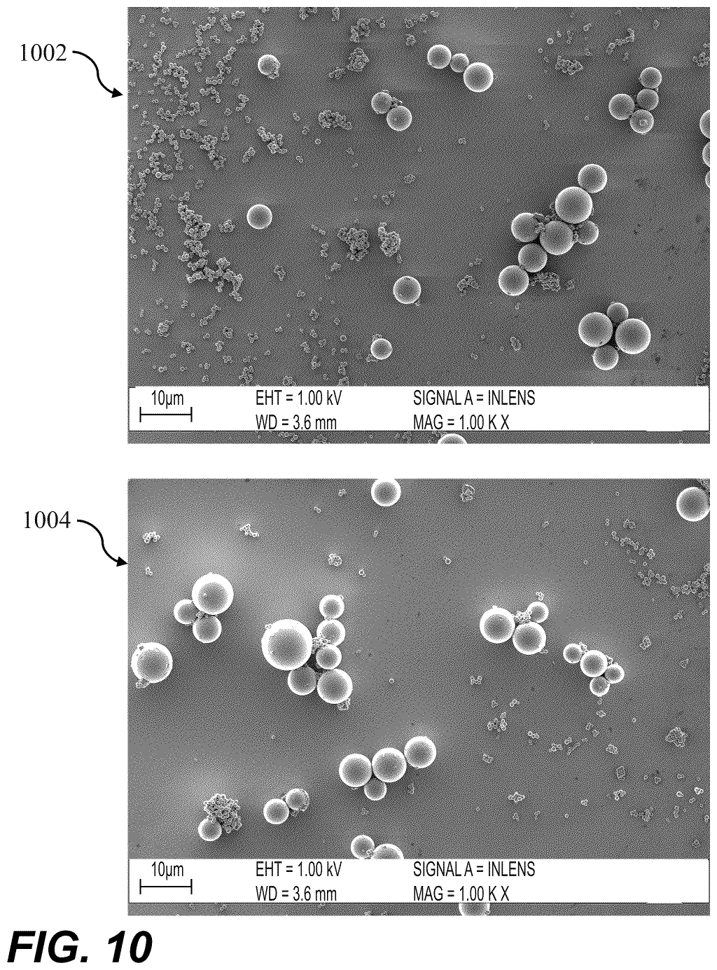

Mixtures of composite particles may be obtained by mixing population samples C1 and C5 at respective population mass fractions. FIG. 10 shows SEM images 1002, 1004 of composite particles. SEM image 1002 shows composite particles taken from population sample C3 obtained by mixing population samples C1 and C5 at a population mass fraction of about 0.75. SEM image 1004 shows composite particles taken from population sample C4 obtained by mixing population samples C1 and C5 at a population mass fraction of about 0.85. In the examples shown, the composite particles are round and may be spheroidal or substantially spherical. Other mixtures of composite particles were also obtained, including population sample C2 obtained by mixing population samples C1 and C5 at a population mass fraction of about 0.55.

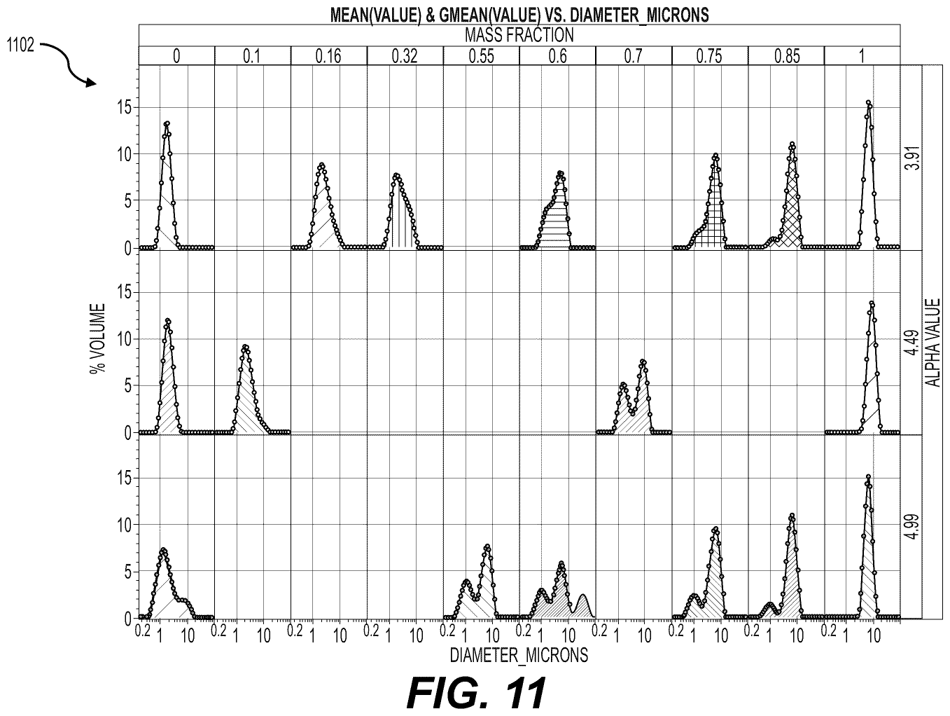

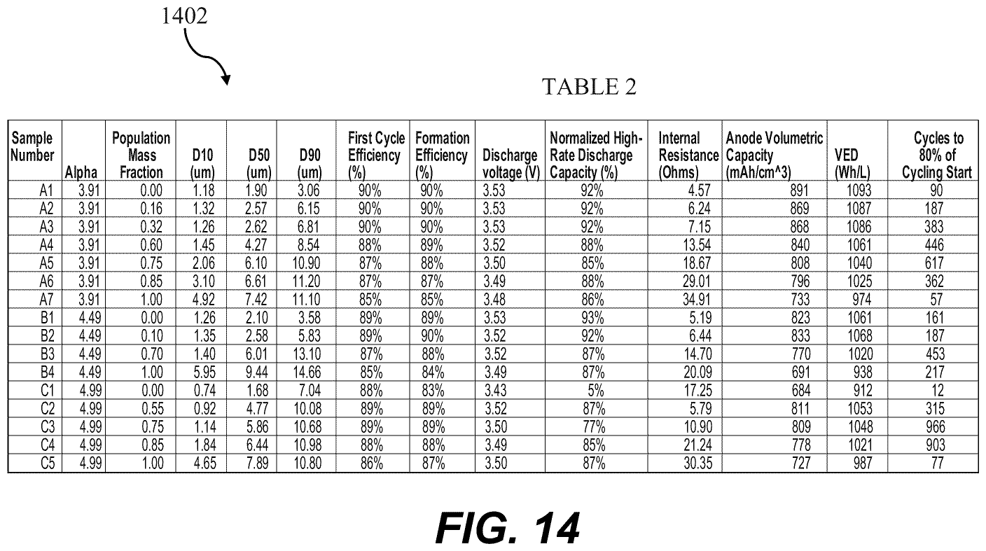

Particle size distributions (PSDs) were characterized for each of the example population samples using laser particle size distribution analysis (LPSA). FIG. 11 shows graphical plots 1102 of the PSDs of each of the example populations, arranged in rows of respective size ratio α values and columns of population mass fraction values. FIG. 13 and FIG. 14 show, respectively, Table 1 (1302) and Table 2 (1402), which show selected particle characteristics, coating characteristics, and battery cell performance characteristics for each of the example populations of composite particles. In Table 1 (1302) and Table 2 (1402), each example population is identified by the population sample number (e.g., A1, B1, C1), the size ratio α, and the population mass fraction (mass fraction of the larger particle population). Table 1 (1302) shows values of D₁₀, D₅₀, D₉₀, D₉₉, D₉₀−D₁₀ (full width), D₅₀−D₁₀ (left width), and D₉₀−D₅₀ (right width) for each example population, obtained from measuring the respective PSDs by LSPA.

Additionally, Table 1 (1302) reports the BET-SSA and the Si mass fraction for each of the example populations. The BET-SSA of each example population of composite particles was measured by nitrogen gas physisorption (around 77 K) of powder samples that had been degassed at about 300° C. for about 10 hours under vacuum. The silicon (Si) mass fraction was estimated by thermogravimetric analysis (TGA) of a powder sample in a crucible that was heated to about 900° C. (ramp rate of about 40° C./min) in air and held for about 60 minutes. The sample was then allowed to cool to room temperature and the resulting mass was assumed to be entirely silicon oxide. Under this assumption, the amount of silicon that would have been present in the original powder sample was calculated. In the examples shown, the BET-SSA ranged between about 1.3 m²/g to about 15.2 m²/g. The larger particle parent populations (e.g., A7, B4, C5) tended to exhibit lower BET-SSA values ranging between about 1.3 m²/g and about 2.2 m²/g. On the other hand, the smaller particle parent populations (e.g., A1, B1, C1) tended to exhibit higher BET-SSA values ranging between about 8.2 m²/g and about 15.2 m²/g. The mixed populations obtained by mixing the parent populations exhibited BET-SSA values in between the BET-SSA values of the respective parent populations. In the examples shown, the Si mass fractions ranged between about 40.86 wt. % and about 43.29 wt. %. In some implementations, the silicon mass fraction in the composite particles may be in a range of about 35 wt. % to about 50 wt. % (e.g., about 35-about 40 wt. %, about 40-about 45 wt. %, about 45-about 50 wt. %, etc.). In some implementations, the silicon mass fraction in the composite particles may be in a range of about 35 wt. % to about 70 wt. % (e.g., about 35-about 50 wt. %, about 50-about 60 wt. %, about 60-about 70 wt. %, etc.). In some implementations, the silicon mass fraction in the composite particles may be in a range of about 33 wt. % to about 60 wt. %. In some implementations, the silicon mass fraction in the composite particles may be in a range of about 40 wt. % to about 55 wt. %. In some embodiments, a mass fraction of the silicon in the nanocomposite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 35 wt. % to about 70 wt. %; in yet other designs, from about 33 wt. % to about 60 wt. %; in yet other designs, from about 40 wt. % to about 55 wt. %).

Electrode coatings for the illustrative examples were prepared using each of the battery electrode compositions comprising a parent population of composite particles or mixtures of composite particles. In addition to the composite particles, a battery electrode composition may include functional additives (e.g., additives that enhance electrical conductivity or rate performance of mechanical properties of the electrode), such as carbon-comprising functional additives. Examples of suitable carbon-comprising functional additives are carbon nanotubes (single-walled carbon nanotubes, abbreviated as SWCNTs, multi-walled carbon nanotubes, abbreviated as MWCNTs), carbon nanofibers, carbon black, graphite, exfoliated graphite, graphene oxide (e.g., single-walled graphene oxide, multi-walled graphene oxide), and graphene (e.g., single-walled graphene, multi-walled graphene). Slurries were prepared by thoroughly mixing the nanocomposite particles (e.g., at a mass fraction in a range of about 87 wt. % to about 94 wt. %, or in a range of about 89 wt. % to about 92 wt. %, of the solids content of the slurry), a binder composition (e.g., at a mass fraction in a range of about 6 wt. % to about 13 wt. %, or in a range of 8 wt. % to about 10 wt. %, of the solids content of the slurry), functional additives (e.g., at a mass fraction in a range of about 0 wt. % to about 0.1 wt. % of the solids content of the slurry), and a solvent composition (e.g., at a mass fraction of 10 wt. % to about 40 wt. % of the slurry). The illustrative example anode slurries were then casted onto a copper foil and dried at room temperature to form an electrode coating. Subsequently, dried electrode coatings were calendered (in the disclosed illustrative examples, by using a constant force) to obtain a coating density in a specific range, e.g., in a range of about 0.75 g/cm³ to about 1.00 g/cm³, or in a range of about 0.80 g/cm³ to about 1.00 g/cm³ or in a range of about 0.85 g/cm³ to about 1.00 g/cm³, or in a range of about 0.90 g/cm³ to about 1.00 g/cm³. Note that higher density (e.g., designs with about 1.0 to about 1.2 g/cm³, designs with about 1.2 to about 1.5 g/cm³ or more) may preferably be attained for blended anodes comprising small-to-large fractions of soft or hard graphite (broadly, soft or hard carbon) or their various mixtures (e.g., about 5-80% of capacity provided by graphite and about 20-95% capacity provided by Si—C nanocomposite or other Si-comprising particles).

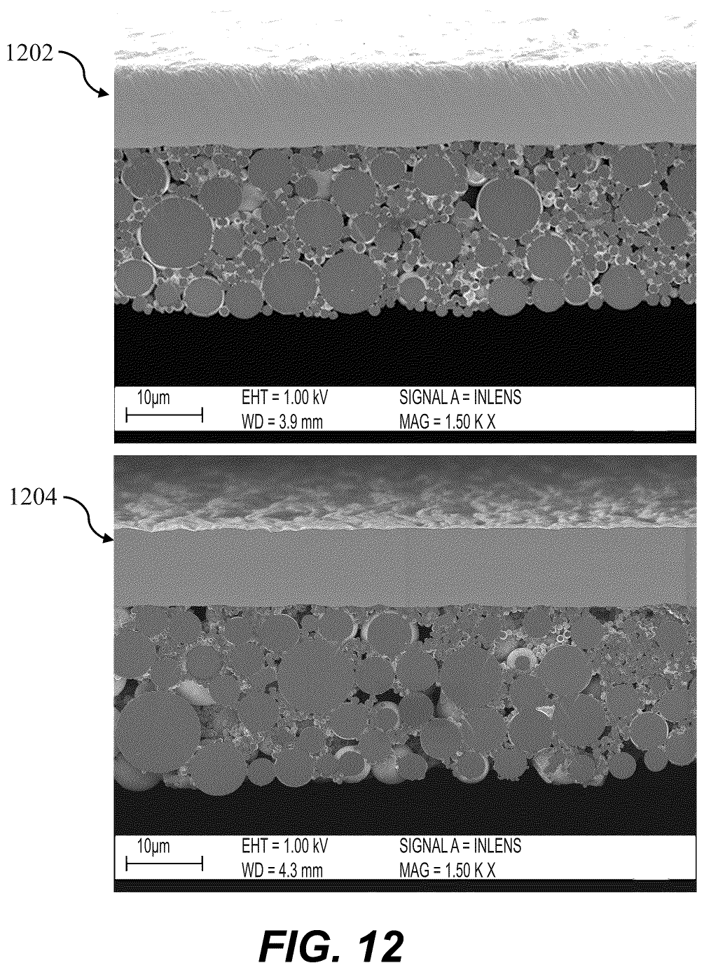

FIG. 12 shows SEM images 1202, 1204 of cross sections of illustrative example electrode coatings. SEM image 1202 shows an electrode coating obtained using population sample A6 (α≈3.91, population mass fraction of about 0.85). SEM image 1204 shows an electrode coating obtained using population sample C4 (α≈4.99, larger composite particle population mass fraction of about 0.85), respectively. In the examples shown, the composite particles are round in a cross section. In the examples shown in FIG. 12, the electrode coatings contained composite particles, binder, and functional additives.

Table 1 (1302) reports the coating thickness (in μm) and coating density (in g/cm³) for each electrode coating. The coating thickness was measured by a Keyence GT2-PA12K Drop Gauge. For each electrode coating, the weight of the coating (excluding the current collector) and area of the coating were measured to determine an areal loading (mg/cm²) (not shown in Table 1). For each electrode coating, the coating density was derived from the coating thickness and areal loading. In the examples shown, the coating thickness ranged between about 22.96 μm and about 27.96 μm. In the examples shown, the coating density ranged between about 0.88 g/cm³ and about 1.00 g/cm³. In some embodiments, the coating thickness may be in a range of about 0.9 g/cm³ to about 1.0 g/cm³.

Conventional anode active materials utilized in Li-ion batteries are of an intercalation-type. Metal ions are intercalated into and occupy interstitial positions of such materials during the charge or discharge of a battery. Such anodes experience small or very small volume changes (e.g., less than about 8 vol. %) when used in electrodes. Polyvinylidene fluoride (also referred to as polyvinylidene difluoride (PVDF)), polyacrylic acid (PAA) (or its salts, derivatives, and copolymers) (sometimes mixed with styrene butadiene rubber, SBR), and carboxymethyl cellulose (CMC) (often mixed with styrene butadiene rubber, SBR) are the most common binders used in these electrodes. Carbon black is the most common conductive additive used in these electrodes. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode active materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano) composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorus (P), boron (B) or other elements or be allowed with metals. In addition to Si-based composites, silicon oxides (SiOₓ) or oxynitrides (SiOₓN_{y}) or nitrides (SiN_{y}) or phosphides (SiP_{y}) or other Si element-comprising particles (including those that are partially reduced by Li or Mg) may reduce volume changes and improve cycle stability, although commonly at the expense of higher first cycle losses or faster degradation or both. In some designs, Si-comprising anode particles may exhibit high gravimetric lithiation capacities in the range from about 800 mAh/g to about 3000 mAh/g (per mass of Si-comprising anode particles in a Li-free state; in some designs—from about 800 mAh/g to about 1400 mAh/g; in other designs—from about 1400 mAh/g to about 2200 mAh/g; in other designs—from about 2200 mAh/g to about 2600 mAh/g; in other designs—from about 2600 mAh/g to about 3000 mAh/g), as measured in lithium half cells in the potential range for first cycle lithiation from its open circuit potential down to 0.01 V vs. Li/Li⁺ at about C/10 constant current rate with a potential hold at 0.01 V till the current drops to about C/100 and first cycle dilithiation from 0.01V to about 1.5V vs. Li/Li⁺ at a C/10 constant current rate). Such high specific capacity is advantageous for attaining lighter batteries. However, Li-ion battery cells with anodes comprising high capacity anode particles of unoptimized particle size distribution (PSD) may exhibit undesirably fast degradation in conventional electrolytes (especially when processed with conventional binders and conductive additives at typical areal capacity loadings), particularly at elevated temperatures or when charged to high voltages (e.g., above about 4-4.3 V). A subset of anodes with Si-comprising anode particles includes anodes with the electrode layer exhibiting capacity in the range from about 400 mAh/g to about 2800 mAh/g (per mass of the electrode layer, not counting the mass of the current collector, in a Li-free state; in some designs—from about 400 mAh/g to about 500 mAh/g; in other designs—from about 500 mAh/g to about 700 mAh/g; in other designs—from about 700 mAh/g to about 1000 mAh/g; in other designs—from about 1000 mAh/g to about 1200 mAh/g; in other designs—from about 1200 mAh/g to about 1500 mAh/g; in other designs—from about 1500 mAh/g to about 2000 mAh/g; in other designs—from about 2000 mAh/g to about 2800 mAh/g). Such a class of charge-storing anodes offer great potential for increasing gravimetric and volumetric energy of rechargeable batteries. However, Li-ion battery cells with anodes comprising high capacity anode particles of unoptimized PSD may exhibit undesirably fast degradation in conventional electrolytes and when processed with conventional binders and conductive additives at typical areal capacity loadings, particularly at elevated temperatures (e.g., battery operating temperatures, e.g., about 50-80° C. or higher) or when charged to high voltages (e.g., above about 4-4.3 V). In addition to Si-comprising anodes, other examples of such high capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorus, silver, cadmium, indium, tin, lead, bismuth, their alloys, and others. In addition to anodes comprising active materials in the metallic form, other interesting types of high capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) active materials may exhibit undesirably fast degradation in conventional electrolytes, particularly at elevated temperatures or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) anode active materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with alloying-type (or, more broadly, conversion-type) anode active materials may become particularly undesirably fast for cells comprising medium (e.g., about 3-4 g/Ah) or small (e.g., about 2-3 g/Ah) amount of electrolyte when normalized by total cell capacity. However, using a medium or a small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions. One or more aspects of the present disclosure enables one to mitigate or overcome some or all of such limitations and substantially enhance performance of such Li-ion cells by using certain disclosed compositions and certain disclosed properties of active materials. One or more aspects of the present disclosure enables one to mitigate or overcome some or all of such limitations and substantially enhance performance of such Li-ion cells by using certain disclosed PSD of the anode active material particles (e.g., active material particles comprising alloying or conversion-type active materials).

High-capacity (nano) composite anode powders (including, but not limited to those that comprise Si), which exhibit moderately high volume changes (e.g., about 8-about 180 vol. %) during the first charge-discharge cycle, moderate volume changes (e.g., about 5-about 50 vol. %) during the subsequent charge-discharge cycles and an average size in the range from about 0.2 to about 40 microns (for some applications, more preferably from about 0.4 to about 20 microns) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (above about 12 mAh/cm²) are also particularly attractive for use in cells. In some designs, a spheroidal (including near-spherical) or an ellipsoid (including oblate spheroid) shape of these composite particles may additionally be very attractive for increasing rate performance and volumetric capacity (density) of the electrodes. In other designs, jagged composite particles, cylindrical shaped composite particles or irregularly shaped composite particles may still be used effectively. Unfortunately, unoptimized PSD of such particles may lead to poor performance in batteries.

Higher electrode density and lower binder content are advantageous for increasing cell energy density and reducing cost in certain applications. Lower binder content may also be advantageous for increasing cell rate performance. Larger volume changes lead to inferior performance in some designs, which may be related to damages in the solid electrolyte interphase (SEI) layer formed on the anode, to the non-uniform lithiation and delithiation of the electrode particles within the electrodes, and other factors. Unfortunately, Li and Li-ion battery cells with such anodes having unoptimized PSD of active (e.g., Si-comprising) materials often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V.

Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (e.g., above about 50-90° C.) in a fully charged state (e.g., about 90-100% state-of-charge, SOC) for a prolonged time (e.g., about 12-168 hours). Passing such elevated temperature charging tests is often required for most applications. In some designs, degradation of Li-ion cells comprising high-capacity (nano) composite anode powders having unoptimized PSD, which exhibit moderately high volume changes during the first charge-discharge cycle, moderate volume changes during the subsequent charge-discharge cycles and an average size in the range from about 0.2 to about 40 microns may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, Li-ion cells with such volume changing anode particles may degrade particularly undesirably fast for cells comprising medium (e.g., about 3-4 g/Ah) or small (e.g., about 2-3 g/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

One or more embodiments of the present disclosure overcome some or all of the above-discussed challenges of various types of metal-ion (e.g., Li-ion) cells comprising high-capacity nanocomposite anode active materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 5-about 50 vol. %) during the subsequent charge-discharge cycles), may exhibit an average particle size in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 4 g/mAh), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., about 70-100% SOC) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

In some designs, swelling of binders in electrolytes depends not just on the binder composition, but may also depend on the electrolyte compositions. Furthermore, in some designs, such swelling (and the resulting performance reduction) often correlates with the reduction in elastic modulus upon exposure of binders to electrolytes. In this sense, the smaller the reduction in modulus in certain electrolytes, the more stable the binder-linked (nano) composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

In one or more embodiments of the present disclosure, a preferred battery cell includes a lithium cobalt oxide (LCO) as a cathode active material. In another one or more embodiments of the present disclosure, a preferred battery cell includes a lithium nickel cobalt manganese oxide (NCM) as a cathode active material. In another one or more embodiments of the present disclosure, a preferred battery cell includes a lithium nickel cobalt manganese aluminum oxide (NCMA) as a cathode active material. In another one or more embodiments of the present disclosure, a preferred battery cell includes a lithium nickel cobalt aluminum oxide (NCA) as a cathode active material. In another one or more embodiments of the present disclosure, a preferred battery cell includes a high voltage spinel (e.g., lithium nickel manganese oxide (LNMO) or lithium manganese oxide (LMO)) as a cathode active material. In some designs, LCO, NCM, NCMA, NCA, LNMO or LMO cathode active materials may include the majority (e.g., over about 50 wt. %) of single-crystalline powder (or a powder with grain size above around 500 nm; in some designs, above around 1 micron). In some of the preferred examples a surface of LCO, NCM, NCMA, NCA, LMO or LMNO may be coated with a layer of ceramic material. Illustrative examples of a preferred coating material for such cathodes include, but are not limited to, titanium oxide (e.g., TiO₂), aluminum oxide (e.g., Al₂O₃), tungsten oxide (e.g., WO), chromium oxide (e.g., Cr₂O₃), niobium oxide (e.g., NbO or NbO₂) and zirconium oxide (e.g., ZrO₂) and their various mixtures. In some designs, such ceramic materials may additionally comprise lithium (Li)—e.g., as lithium titanium oxide, lithium aluminum oxide, lithium tungsten oxide, lithium chromium oxide, lithium niobium oxide, lithium zirconium oxide and their various alloys, mixtures and combinations. In other preferred examples, LCO, NCM, NCMA, NCA, LMFP, LMP, LMO or LMNO may be doped with A1, Ti, Mg, Nb, Zr, Cr, Hf, Ta, W, Mo or La. In some designs, a preferred cathode current collector material is aluminum or aluminum alloy. In some designs, a preferred battery cell includes a polymer separator. In some of the preferred examples, a polymer separator is made of or comprises polyethylene, polypropylene or a mixture thereof. In some of the preferred examples, a surface of a polymer separator is coated with a layer of ceramic material. Examples of a preferred coating material for polymer separators may include, but not limited to titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell may include a silicon- and carbon-comprising nanocomposite (e.g., as used herein, a nanocomposite or (nano) composite is at least partially comprised of active material nanomaterials or nanostructures or nanoparticles, irrespective of whether the nanocomposite or (nano) composite itself is a nanomaterial) or silicon (SiOₓ, x≥0) or natural or synthetic graphite or soft carbon or hard carbon or their various mixtures and combinations in its anode composition. In some of the preferred examples, the anode active material includes a mixture of silicon- and carbon-comprising nanocomposite (sometimes abbreviated herein as Si—C nanocomposite) and graphite (e.g., the graphite-being distinct from the C-part of the Si—C nanocomposite particles). In some implementations, a Si—C nanocomposite comprises composite particles, which may include Si nanoparticles embedded in pores (e.g., surface pores or internal pores such as closed internal pores or open internal pores) of a porous carbon scaffold particle. Such a porous carbon scaffold particle may comprise (e.g., curved or defective) graphene material and/or graphite material. In some designs, a preferred anode current collector may comprise copper or copper alloy.

In one or more embodiments of the present disclosure, a preferred anode for a battery cell may comprise a mixture of Si—C nanocomposite (particles) and graphite (particles) as the anode active material, a so-called blended anode. In addition to the anode active material-comprising particles, an anode may comprise inactive material, such as binder(s) (e.g., polymer binder) and other functional additives (e.g., surfactants, electrically conductive additives). In some implementations, the anode active material (particles) may be in a range of about 90 wt. % to about 98 wt. % of the anode. For example, the anode active material (particles) may be about 95.5 wt. % of the anode, in some designs.

In some designs, a blended anode may comprise from about 7 wt. % of Si—C nanocomposite to about 97 wt. % of the Si—C nanocomposite (e.g., particles). While the descriptions below may also describe certain examples of the blended anode formulations expressed as mass (wt. %) of Si—C nanocomposite (e.g., particles) relative to the total weight of Si—C composite particles and graphite-comprising particles in a blend, it will be appreciated that various aspects of this disclosure may be applicable to blended anode formulations expressed as wt. % of Si in the anode (e.g., including the weight of conductive and other additives, binder, Si-comprising composites such as Si—C nanocomposites, and graphite). For example, in some implementations, a blended anode composition of about 7 wt. % of Si—C nanocomposite (e.g., particles) corresponds to about 3-3.5 wt. % of Si in the blended anode. In some implementations, a blended anode composition of about 19 wt. % of Si—C nanocomposite (e.g., particles) corresponds to about 8-10 wt. % of Si in the blended anode. In some implementations, a blended anode composition of about 35 wt. % of Si—C nanocomposite (e.g., particles) may correspond to about 15-18 wt. % of Si in the blended anode. In some implementations, a blended anode composition of about 50 wt. % of Si—C nanocomposite (e.g., particles) may correspond to about 21-30 wt. % of Si in the blended anode. In respective implementations, blended anodes may be obtained in which the mass (weight) of the silicon is in a range of about 3 wt. % to about 30 wt. % of a total mass of the anode. Herein, the term “total mass of the anode” is used to refer to the mass of the anode only, excluding any anode current collector foil or separator. The masses of the current collector and the separator are excluded from the mass of the anode even if the current collector and the separator are attached to the anode.

In some designs, a blended anode may comprise Si—C nanocomposite (e.g., particles) that provides from about 25% of to about 99.5% of the total anode capacity. While the descriptions below may also describe certain examples of the blended anode formulations expressed as mass (wt. %) of Si—C nanocomposite (e.g., particles), it will be appreciated that various aspects of this disclosure may be applicable to blended anode formulations attributing a fraction (e.g., %) of the total capacity of the blended anode to the capacity of the Si. For example, in some implementations, about 25% of the total capacity of the blended anode may be obtained from the Si—C nanocomposite (e.g., particles) in a blended anode composition of about 7 wt. % of Si—C nanocomposite (e.g., particles). In some other implementations, about 50% of the total capacity of the blended anode may be obtained from the Si—C nanocomposite (e.g., particles) in a blended anode composition of about 19 wt. % of Si—C nanocomposite (e.g., particles). In some other implementations, about 70% of the total capacity of the blended anode may be obtained from the Si—C nanocomposite (e.g., particles) in a blended anode composition of about 35 wt. % of Si—C nanocomposite (e.g., particles). In some other implementations, about 80% of the total capacity of the blended anode may be obtained from the Si—C nanocomposite (e.g., particles) in a blended anode composition of about 50 wt. % of Si—C nanocomposite (e.g., particles).

In some implementations, blended anodes may comprise Si—C nanocomposites (e.g., particles) ranging from about 7 wt. % to about 99 wt. % of the anode active material particles and the graphite particles making up the remainder of the mass (the weight) of the anode active material particles. In some implementations in which the anode active material particles are about 95.5 wt. % of the blended anode, the blended anode (including active material particles and inactive material) may comprise about 7 wt. % of Si—C nanocomposite (e.g., particles) and about 88.5 wt. % of graphite (e.g., particles), about 19 wt. % of Si—C nanocomposite (e.g., particles) and about 76.5 wt. % of graphite (e.g., particles), about 35 wt. % of Si—C nanocomposite (e.g., particles) and about 60.5 wt. % of graphite (e.g., particles), or about 50 wt. % of Si—C nanocomposite (e.g., particles) and about 45.5 wt. % of graphite (e.g., particles, with the graphite particles being distinct from the C-part of the Si—C nanocomposite in all cases). In some of the preferred examples in which the anode active material particles are about 90 wt. % or more of the blended anode, the anode active material composition may comprise a small (e.g., about 1-20 wt. %, preferably about 1-10 wt. %, and even more preferably about 1-5 wt. %) fraction of graphite (e.g., particles, with the graphite particles being distinct from the C-part of the Si—C nanocomposite).

In some of the illustrative examples in which the anode active material particles are about 90 wt. % of the anode, the anode active material particle composition may consist almost entirely of Si—C nanocomposite (e.g., particles) and is substantially free of graphite particles (e.g., <about 1 wt. %) (e.g., the graphite particles, if present at all, being distinct from the C-part of the Si—C nanocomposite).

In some of the illustrative examples in which the anode active material particles are about 96.5 wt. % of the anode, the anode active material particle composition may consist almost entirely of graphite and is substantially free of Si—C nanocomposite (e.g., <about 1 wt. %).

In one or more embodiments of the present disclosure, an electrolyte comprising esters and/or carbonates (e.g., cyclic carbonates, linear carbonates) may be employed in a lithium-ion battery cell. The lithium-ion battery comprises an anode current collector (e.g., a foil of copper or copper alloy), a cathode current collector (e.g., a foil of aluminum or aluminum alloy), an anode disposed on and/or in the anode current collector, a cathode disposed on or in the cathode current collector, and any of the foregoing electrolytes ionically coupling the anode and the cathode. In some examples, a separator (e.g., a separator film or coating) may be disposed between the anode and the cathode, with at least some of the electrolyte infiltrating or impregnating the separator. The anode may comprise any suitable anode active material(s) as described herein. For example, the anode may comprise silicon-carbon composite (e.g., nanocomposite) particles comprising silicon and carbon. In some implementations, a mass of the silicon may be in a range of about 3 wt. % to about 80 wt. % of a total mass of the anode. In some cases, at least some of the silicon may be present in the silicon-carbon composite particles as nanosized or nanostructured silicon. For example, the anode may comprise graphitic carbon particles comprising carbon. In some cases, the graphitic carbon particles may be substantially free of silicon. In some cases, the silicon-carbon composite particles and the graphitic carbon particles may both be present in an anode.

In one illustrative example, Li-ion battery cell with capacity of about 0.028 Ah may comprise: (i) an anode with about 100% by capacity Si—C nanocomposite active material (e.g., particles) (with specific reversible capacity of about 1600 to about 1700 mAh/g when normalized by the weight of active materials in the anode), which corresponds to about 40 to about 44 wt. % of silicon mass fraction in the Si—C composite particles casted on Cu current collector foil from a water-based suspension comprising a polyacrylic acid (PAA) salt copolymer-based binder and about 0.1 wt. % of carbon black conductive additive, (ii) a cathode with high-voltage lithium cobalt oxide (LCO) active material (with specific reversible capacity of about 170 mAh/g when normalized by the weight of active materials in the cathode) casted on A1 current collector foil from an organic solvent suspension comprising a polyacrylic acid (PAA)-based binder and a carbon black conductive additive, anode:cathode areal capacity ratio of about 1.15:1 and areal reversible capacity loading of about 3.5 mAh/cm², charge voltage of about 4.4V, (iii) a polymer-ceramic separator, and (iv) an electrolyte ELY #1 comprising: about 15 mol. % of FEC, about 44 mol. % of ethyl propionate (EP) (linear ester), about 7 mol. % of LiPF₆, about 24 mol. % of non-fluorinated cyclic carbonates, about 7 mol. % of diethyl carbonate (DEC), and about 3 mol. % of other compounds.

Li-ion battery test cells respectively comprising the example composite particles were tested in a cycle life test (data shown in Table 2 (1404) of FIG. 14). The test cells were fabricated, and an initial formation procedure was carried out on the test cells. Charge/discharge test conditions comprise constant current, constant potential (CCCP) at 2 C charge to 4.0V and taper to 1 C, followed by the CCCP at 1 C charge to 4.4V and taper to 0.05 C, followed by 1 C discharge. For each lithium-ion battery cell, Table 2 (1402) reports the first-cycle efficiency, formation efficiency, discharge voltage, normalized high-rate discharge capacity, internal resistance, anode volumetric capacity, volumetric energy density, and number of cycles to reach 80% of cycling start capacity. First-cycle efficiency is defined as the first-cycle discharge capacity divided by the first-cycle charge capacity. Formation efficiency is defined as cycling start discharge capacity (discharge capacity upon completion of cycle 3) divided by the first cycle charge capacity. Discharge voltage is defined as the discharge energy (Wh) divided by discharge capacity (Ah). Normalized high-rate discharge (in this case, 2 C discharge) capacity is defined as the discharge capacity of the cell measured after 2 C discharge divided by the discharge capacity of the cell measured after 0.5 C discharge, with the measurements being carried out after 20 cycles. Internal resistance is determined as follows: A series of millisecond-long current pulses are applied to the cell at a 0% state-of-charge, and the resulting voltages are measured. An average voltage is determined by averaging over the respective voltages that are measured for each of the current pulses. The internal resistance is the average voltage divided by the applied current. Anode volumetric capacity is defined as the anode capacity (after the fourth cycle) (expressed in mAh) divided by anode volume (expressed in cm³). Volumetric energy density (sometimes abbreviated as VED) is defined as the cell energy (after the fourth cycle) (expressed in Wh) divided by the cell's external volume (expressed in liters). Volumetric energy density is defined as cell energy (expressed in Wh) normalized to the cell external volume (expressed in L). Number of cycles to reach 80% of cycling start capacity (during cycling at 25° C.) is also referred to as cycle life. The cycling start capacity is defined as the capacity upon completion of the third cycle. The cycle life is also reported in Table 1 (1302) for each lithium-ion battery cell.

In the examples shown (Tables 1 and 2), there is a wide variation in the cycle life values, ranging between 12 cycles and 965 cycles. Some populations exhibit D₅₀-D₁₀ (left width) values that are smaller than about 1.0 μm and some lithium-ion battery test cells made using these populations exhibit poor cycle life (e.g., A1 exhibits D₅₀−D₁₀ of about 0.72 μm and cycle life of about 90 cycles, B1 exhibits Dso-D₁₀ of about 0.84 μm and cycle life of about 161 cycles, and C1 exhibits D₅₀−D₁₀ of about 0.94 μm and cycle life of about 12 cycles). Accordingly, in some implementations the composite particles may be selected such that the left width (D₅₀−D₁₀) of the PSD is at least about 1.0 μm. Note that these foregoing particle populations A1, B1, and C1 are smaller particle-only populations. In some implementations, there may be a beneficial effect from adopting populations with PSDs that are wider than those of these smaller particle-only populations. For example, beneficial effects may be obtained by mixing smaller particle and larger particle populations, or otherwise obtaining populations with wider PSDs.

Some populations exhibit D₅₀−D₁₀ (left width) values that are less than about 1.5 μm (and at least 1.0 μm) and some lithium-ion battery test cells made using these populations exhibit poor cycle life (e.g., A2 exhibits D₅₀−D₁₀ of about 1.25 μm and cycle life of about 187 cycles, and B2 exhibits Dso-D₁₀ of about 1.23 μm and cycle life of about 187 cycles). Accordingly, in some implementations, the composite particles may be selected such that the left width (D₅₀−D₁₀) of the PSD is at least 1.5 μm.

Some populations exhibit D₅₀−D₁₀ (left width) values that are greater than about 3.3 μm and some lithium-ion battery test cells made using these populations may exhibit better cycle life (e.g., A5 exhibits D₅₀−D₁₀ of about 4.04 μm and cycle life of about 617 cycles, B3 exhibits D₅₀−D₁₀ of about 4.61 μm and cycle life of about 453 cycles, C3 exhibits D₅₀−D₁₀ of about 4.72 μm and cycle life of about 965 cycles, and C4 exhibits D₅₀−D₁₀ of about 4.59 μm and cycle life of about 903 cycles). Accordingly, in some implementations, the composite particles may be selected such that the left width (D₅₀−D₁₀) of the PSD is at least about 3.3 μm, at least about 3.6 μm, at least about 3.9 μm, or at least about 4.0 μm. In some embodiments, a left width (D₅₀−D₁₀) of the PSD is at least about 1.0 μm (in some designs, at least about 1.0 μm; in other designs, at least about 1.5 μm; in yet other designs, at least about 3.3 μm). In some embodiments, the left width (D₅₀−D₁₀) of the PSD is at most about 8.2 μm (in some designs, at most about 8.2 μm; in other designs, at most about 8.0 μm; in yet other designs, at most about 7.0 μm; in yet other designs, at most about 6.0 μm; in yet other designs, at most about 5.0 μm).

Some populations exhibit D₉₀−D₅₀ (right width) values that are smaller than about 1.8 μm and some lithium-ion battery test cells made using these populations exhibit poor cycle life (e.g., A1 exhibits D₉₀−D₅₀ of about 1.16 μm and cycle life of about 90 cycles, and B1 exhibits D₉₀−D₅₀ of about 1.48 μm and cycle life of about 161 cycles). Accordingly, in some implementations the PSD may be selected such that the right width (D₉₀−D₅₀) of the PSD is at least 1.8 μm. Note that these foregoing particle populations A1 and B1 are smaller particle-only populations. In some implementations, there may be a beneficial effect from adopting populations with PSDs that are wider than those of these smaller particle-only populations. For example, beneficial effects may be obtained by mixing smaller particle and larger particle populations, or otherwise obtaining populations with wider PSDs.

Some populations exhibit D₉₀−D₅₀ (right width) values that are less than about 3.8 μm (and at least about 1.8 μm) and some lithium-ion battery test cells made using these populations exhibit poor cycle life (e.g., A2 exhibits D₉₀−D₅₀ of about 3.57 μm and cycle life of about 187 cycles, B2 exhibits D₉₀−D₅₀ of about 3.25 μm and cycle life of about 187 cycles, and C5 exhibits D₉₀−D₅₀ of about 3.71 μm and cycle life of about 77 cycles). Accordingly, in some implementations, the composite particles may be selected such that the right width (D₉₀−D₅₀) of the PSD is at least about 3.8 μm.

Some populations exhibit D₉₀−D₅₀ (right width) values that are greater than about 4.4 μm and some lithium-ion battery test cells made using these populations exhibit better cycle life (e.g., A5 exhibits D₉₀−D₅₀ of about 4.80 μm and cycle life of about 617 cycles, B3 exhibits D₉₀−D₅₀ of about 7.09 μm and cycle life of about 453 cycles, C3 exhibits D₉₀−D₅₀ of about 4.82 μm and cycle life of about 965 cycles, and C4 exhibits D₉₀−D₅₀ of about 4.54 μm and cycle life of about 903 cycles). Accordingly, in some implementations the composite particles may be selected such that the right width (D₉₀-D₅₀) of the PSD is at least about 4.4 μm. In some embodiments, a right width (D₉₀−D₅₀) of the PSD is at least about 1.5 μm (in some designs, at least about 1.8 μm; in other designs, at least about 3.8 μm; in yet other designs, at least about 4.4 μm). In some embodiments, the right width (D₉₀−D₅₀) of the PSD is at most about 18.0 μm (in some designs, at most about 18.0 μm; in other designs, at most about 15.0 μm; in yet other designs, at most about 12.0 μm; in yet other designs, at most about 10.0 μm; in yet other designs, at most about 8.0 μm; in yet other designs, at most about 6.0 μm).

Some populations exhibit BET SSA values that are greater than about 7 m²/g, greater than about 8 m²/g, greater than about 10 m²/g, greater than about 12 m²/g, greater than about 13 m²/g, greater than about 14 m²/g, or greater than about 15 m²/g, and some lithium-ion battery test cells made using these populations exhibit poor cycle life (e.g., A1 exhibits BET SSA of about 8.8 m²/g and cycle life of about 90 cycles, A2 exhibits BET SSA of about 7.5 m²/g and cycle life of about 187 cycles, B1 exhibits BET SSA of about 8.2 m²/g and cycle life of about 161 cycles, B2 exhibits BET SSA of about 7.6 m²/g and cycle life of about 187 cycles, and C1 exhibits BET SSA of about 15.2 m²/g and cycle life of about 12 cycles). Accordingly, in some implementations the composite particles may be chosen such that the BET SSA is less than about 14 m²/g, less than about 10 m²/g, less than about 8 m²/g, or less than about 7 m²/g. A beneficial effect of particles exhibiting BET SSA values in a moderate range (e.g., less than about 14 m²/g, less than about 10 m²/g, less than about 8 m²/g, or less than about 7 m²/g) may be to limit unwanted side reactions at the particles.

Some populations exhibit BET SSA values that are less than about 2.3 m²/g, less than about 1.8 m²/g, or less than about 1.5 m²/g, and some lithium-ion battery test cells made using these populations exhibit poor cycle life (e.g., A7 exhibits BET SSA of about 1.7 m²/g and cycle life of about 57 cycles, B4 exhibits BET SSA of about 2.2 m²/g and cycle life of about 217 cycles, and C5 exhibits BET SSA of about 1.3 m²/g and cycle life of about 77 cycles). Accordingly, in some implementations the composite particles may be chosen such that the BET SSA is greater than about 1.5 m²/g, greater than about 1.8 m²/g, or greater than about 2.3 m²/g. In some implementations, the composite particles may be chosen such that the BET SSA is in a range of about 1.5 m²/g to about 14.0 m²/g, in a range of 1.5 m²/g to about 8.0 m²/g, in a range of about 2.3 m²/g to about 14.0 m²/g, or in a range of about 2.3 m²/g to about 8.0 m²/g. Note that these foregoing particle populations A7, B4, and C5 are larger particle-only populations. In some implementations, there may be a beneficial effect from adopting populations with PSDs that are wider than those of these larger particle-only populations. For example, beneficial effects may be obtained by mixing smaller particle and larger particle populations, or otherwise obtaining populations with wider PSDs. In some cases, populations exhibiting relatively low BET SSA (e.g., less than about 2.3 m²/g, less than about 1.8 m²/g, or less than about 1.5 m²/g) may correspond to lithium-ion battery cells, with electrodes made using those populations, exhibiting relatively high internal resistance values (e.g., A7 exhibits internal resistance of about 34.91 (2, B4 exhibits internal resistance of about 20.09Ω, and C5 exhibits internal resistance of about 30.35 (2, these are among the higher internal resistance values among the examples shown in Table 2 (1402) of FIG. 14). In some embodiments, a Brunauer-Emmett-Teller (BET) specific surface area (SSA) of the composite particles is in a range of in a range of about 1 m²/g to about 50 m²/g (in some designs, from about 1.5 m²/g to about 14.0 m²/g; in other designs, from about 2.3 m²/g to about 8.0 m²/g; in yet other designs, from about 1 to about 3 m²/g; in yet other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g). In some implementations a BET SSA of about 1.5 m²/g to about 14.0 m²/g may be preferred. In some implementations a BET SSA of about 2.3 m²/g to about 8.0 m²/g may be preferred.

Some populations exhibit D₉₀−D₅₀ (right width) values that are smaller than about 1.8 μm and some lithium-ion battery test cells made using these populations exhibit poor cycle life (e.g., A1 exhibits D₉₀−D₅₀ of about 1.16 μm and cycle life of about 90 cycles, and B1 exhibits D₉₀−D₅₀ of about 1.48 μm and cycle life of about 161 cycles). Accordingly, in some implementations the composite particles may be selected such that the right width (D₉₀−D₅₀) of the PSD is at least about 1.8 μm.

Some populations exhibit Doo values that are less than about 3.2 μm, less than about 5.0 μm, or less than about 8.0 μm, and some lithium-ion battery test cells made using these populations exhibit poor cycle life (e.g., A1 exhibits Doo of about 3.06 μm and cycle life of about 90 cycles, A2 exhibits D₉₀ of about 6.15 μm and cycle life of about 187 cycles, B1 exhibits Doo of about 3.58 μm and cycle life of about 161 cycles, B2 exhibits Doo of about 5.83 μm and cycle life of about 187 cycles, and C1 exhibits Doo of about 7.04 μm and cycle life of about 12 cycles). Accordingly, in some implementations the composite particles may be selected such that Doo of the PSD is at least about 3.2 μm, at least about 5.0 μm, or at least about 8.0 μm. In some embodiments, a ninetieth-percentile volume-weighted particle size parameter (D₉₀) of the PSD is at least about 3.0 μm (in some designs, at least about 3.2 μm; in some other designs, at least about 5.0 μm; in yet some other designs, at least 8.0 μm). In some embodiments, the Doo of the PSD is at most about 20.0 μm (in some designs, at most about 20.0 μm; in some other designs, at most about 18.0 μm; in yet some other designs, at most about 16.0 μm; in yet some other designs, at most about 14.0 μm; in yet other designs, at most about 13.0 μm; in yet other designs, at most about 12.0 μm).

Some populations exhibit D₅₀ values that are greater than about 9.0 μm, greater than about 7.7 μm, or greater than about 7.3 μm, and some lithium-ion battery test cells made using these populations exhibit poor cycle life (e.g., A7 exhibits D₅₀ of about 7.42 μm and cycle life of about 57 cycles, B4 exhibits D₅₀ of about 9.44 μm and cycle life of about 217 cycles, and C5 exhibits D₅₀ of about 7.89 μm and cycle life of about 77 cycles). Accordingly, in some implementations the composite particles may be selected such that D₅₀ of the PSD is not greater than about 9.0 μm, not greater than about 7.7 μm, or not greater than about 7.3 μm.

Some populations exhibit D₅₀ values that are less than about 2.0 μm or less than about 2.7 μm, and some lithium-ion battery test cells made using these populations exhibit poor cycle life (e.g., A1 exhibits D₅₀ of about 1.90 μm and cycle life of about 90 cycles, A2 exhibits D₅₀ of about 2.57 μm and cycle life of about 187 cycles, B1 exhibits D₅₀ of about 2.10 μm and cycle life of about 161 cycles, B2 exhibits D₅₀ of about 2.58 μm and cycle life of about 187 cycles, and C1 exhibits D₅₀ of about 1.68 μm and cycle life of about 12 cycles). Accordingly, in some implementations the composite particles may be selected such that D₅₀ of the PSD is not less than about 2.0 μm, or not less than about 2.7 μm. In some implementations, the composite particles may be selected such that D₅₀ of the PSD falls within some preferred ranges (e.g., in a range of about 2.0 μm to about 9.0 μm, in a range of about 2.0 μm to about 7.7 μm, in a range of about 2.0 μm to about 7.3 μm, in a range of about 2.7 μm to about 9.0 μm, in a range of about 2.7 μm to about 7.7 μm, in a range of about 2.7 μm to about 7.3 μm, in a range of about 2.7 μm to about 12.0 μm, or in a range of about 2.7 μm to about 9.0 μm). In some embodiments, a fiftieth-percentile volume-weighted particle size parameter (D₅₀) of the PSD is in a range of about 1.5 μm to about 12.0 μm (in some designs, from about 2.0 μm to about 9.0 μm; in other designs, from about 2.7 μm to about 7.7 μm; in yet other designs, from about 2.7 μm to about 7.3 μm; in yet other designs, from about 2.7 μm to about 12.0 μm; in yet other designs, from about 2.7 μm to about 9.0 μm).

Some populations exhibit D₁₀ values that are greater than about 5.8 μm, greater than about 4.8 μm, or greater than about 4.5 μm, and some lithium-ion battery test cells made using these populations exhibit poor cycle life (e.g., A7 exhibits D₁₀ of about 4.92 μm and cycle life of about 57 cycles, B4 exhibits D₁₀ of about 5.95 μm and cycle life of about 217 cycles, and C5 exhibits D₁₀ of about 4.65 μm and cycle life of about 77 cycles). Accordingly, in some implementations the composite particles may be selected such that D₁₀ of the PSD is not greater than about 5.8 μm, not greater than about 4.8 μm, or not greater than about 4.5 μm. In some cases, the D₁₀ values being quite high (e.g., greater than about 5.8 μm, greater than about 4.8 μm, or greater than about 4.5 μm) may be related to an insufficient population of smaller particles to relieve mechanical stresses in the electrode coating. On the other hand, the D₁₀ values being quite low (e.g., C1 exhibits D₁₀ of about 0.74 μm and cycle life of about 12 cycles) may be related to an excessive population of fine particles. Accordingly, in some implementations the composite particles may be selected such that D₁₀ of the PSD is not less than about 0.8 μm. In some implementations, the composite particles may be selected such that D₁₀ of the PSD falls within some preferred ranges. In some embodiments, a tenth-percentile volume-weighted particle size parameter (D₁₀) of the PSD is in a range of about 0.5 μm to about 6.0 μm (in some designs, from about 0.8 μm to about 5.8 μm; in other designs, from about 0.8 μm to about 4.8 μm; in yet other designs, from about 0.8 μm to about 4.5 μm).

Process 170 (FIG. 4) includes making a battery electrode composition by mixing at least a first population of first composite particles (e.g., larger particles) and a second population of second composite particles (e.g., smaller particles). Tables 1 and 2 (1302, 1402) of FIG. 14 summarize results, including battery performance characteristics, from example populations that were obtained at size ratios α of about 3.91 (populations A1 through A7), about 4.49 (populations B1 through B4), and about 4.99 (populations C1 through C5), population mass fractions ranging between about 0.00 and 1.00, and D₅₀ values of the first populations (larger particles) of about 7.42 μm (populations A1 through A7), about 9.44 μm (populations B1 through B4), and about 7.89 μm (populations C1 through C5). In some implementations, the parent populations of composite particles may be chosen such that the size ratio α falls within some preferred ranges. In some embodiments, the size ratio α is in a range of about 2.0 to about 7.0 (in some designs, from about 3.0 to about 6.0; in other designs, from about 3.8 to about 5.2). In some implementations, the composite particles may be selected such that D₅₀ of the PSD falls within some preferred ranges. In some embodiments, a fiftieth-percentile volume-weighted particle size parameter (D₅₀^{L}) of the PSD^{L} is in a range of about 5.0 μm to about 12.0 μm (in some designs, from about 6.0 μm to about 10.0 μm; in other designs, from about 7.0 μm to about 9.0 μm). In the examples shown, better cycle life values were observed for higher population mass fraction values. In some embodiments, the population mass fraction is in a range of about 0.20 to about 0.99 (in some designs, from about 0.20 to about 0.95; in other designs, from about 0.30 to about 0.95; in yet other designs, from about 0.40 to about 0.95; in yet other designs, from about 0.50 to about 0.95; in yet other designs, from about 0.60 to about 0.95; in yet other designs, from about 0.70 to about 0.9; in yet other designs, from about 0.55 to about 0.95; in yet other designs, from about 0.55 to about 0.90). In some embodiments, the population mass fraction may be in a range of about 0.40 to about 0.95, or in a range of about 0.50 to about 0.95, or in a range of about 0.55 to about 0.95, or in a range of about 0.55 to about 0.90.

Some aspects of this disclosure may also be applicable to other intercalation-type cathodes (e.g., lithium iron phosphate (LFP), lithium manganese oxide (LMO), lithium manganese nickel oxide (LMNO), lithium iron manganese phosphate (LFMP), etc.) and more conventional intercalation-type (e.g., carbonaceous-such as synthetic or artificial graphites, soft carbons, hard carbons and their various mixtures) anodes and may provide benefits of improved rate performance or improved stability, particularly for electrodes with medium and high capacity loadings (e.g., greater than about 3-4 mAh/cm²).

Battery cell modules or battery cell packs may advantageously comprise cells with electrode and/or electrolyte compositions provided in this disclosure. Such cell modules or packs may offer improved performance characteristics, simplified designs, better safety features or lower cost.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered Clauses:

Clause 1. A battery electrode composition, comprising: a population of composite particles, each of the composite particles comprising silicon and carbon; wherein: the population is characterized by a particle size distribution (PSD) as determined by laser particle size distribution analysis (LPSA) such that; a tenth-percentile volume-weighted particle size parameter (D₁₀) of the PSD is in a range of about 0.8 μm to about 5.8 μm; a fiftieth-percentile volume-weighted particle size parameter (D₅₀) of the PSD is in a range of about 2.0 μm to about 9.0 μm; a ninetieth-percentile volume-weighted particle size parameter (D₉₀) of the PSD is at least 3.2 μm; a left width (D₅₀−D₁₀) of the PSD is at least 1.0 μm; and a right width (D₉₀−D₅₀) of the PSD is at least 1.8 μm.

Clause 2. The battery electrode composition of clause 1, wherein: the D₁₀ is in a range of about 0.8 μm to about 4.8 μm.

Clause 3. The battery electrode composition of clause 2, wherein: the D₁₀ is in a range of about 0.8 μm to about 4.5 μm.

Clause 4. The battery electrode composition of any of clauses 1 to 3, wherein: the D₅₀ is in a range of about 2.7 μm to about 7.7 μm.

Clause 5. The battery electrode composition of clause 4, wherein: the D₅₀ is in a range of about 2.7 μm to about 7.3 μm.

Clause 6. The battery electrode composition of any of clauses 1 to 5, wherein: the D₉₀ is at least 5.0 μm.

Clause 7. The battery electrode composition of clause 6, wherein: the D₉₀ is at least 8.0 μm.

Clause 8. The battery electrode composition of any of clauses 1 to 7, wherein: the left width (D₅₀−D₁₀) is at least 1.5 μm.

Clause 9. The battery electrode composition of clause 8, wherein: the left width (D₅₀−D₁₀) is at least 3.3 μm.

Clause 10. The battery electrode composition of any of clauses 1 to 9, wherein: the right width (D₉₀−D₅₀) is at least 3.8 μm.

Clause 11. The battery electrode composition of clause 10, wherein: the right width (D₉₀−D₅₀) is at least 4.4 μm.

Clause 12. The battery electrode composition of any of clauses 1 to 11, wherein: a mass fraction of the silicon in the composite particles is in a range of about 3 wt. % to about 80 wt. %.

Clause 13. The battery electrode composition of clause 12, wherein: the mass fraction of the silicon is in a range of about 35 wt. % to about 50 wt. %.

Clause 14. The battery electrode composition of any of clauses 1 to 13, wherein: a Brunauer-Emmett-Teller (BET) specific surface area of the composite particles is in a range of 1.5 m²/g to 14.0 m²/g.

Clause 15. The battery electrode composition of clause 14, wherein: the BET specific surface area is in a range of 2.3 m²/g to 8.0 m²/g.

Clause 16. The battery electrode composition of any of clauses 1 to 15, wherein the composite particles are round.

Clause 17. A battery electrode, comprising: the battery electrode composition of clause 1 disposed on or in a current collector, wherein: the battery electrode comprises a binder.

Clause 18. The battery electrode of clause 17, wherein: a coating density of the battery electrode is in a range of about 0.9 to about 1.0 g/cm³.

Clause 19. The battery electrode of any of clauses 17 to 18, wherein: a mass fraction of the silicon in the battery electrode is in a range of about 3 wt. % to about 80 wt. %.

Clause 20. The battery electrode of any of clauses 17 to 19, additionally comprising a carbon-comprising functional additive.

Clause 21. The battery electrode of clause 20, wherein the carbon-comprising functional additive is selected from: carbon nanotubes, carbon nanofibers, carbon black, graphite, exfoliated graphite, graphene oxide, and graphene.

Clause 22. A lithium-ion battery, comprising: an anode current collector; a cathode current collector; the battery electrode of clause 17 configured as an anode, the current collector thereof being configured as the anode current collector; a cathode disposed on or in the cathode current collector; and an electrolyte ionically coupling the anode and the cathode.

Clause 23. A method of making a battery electrode composition, comprising: (A1) providing a first population of first composite particles, each of the first composite particles comprising silicon and carbon; (A2) providing a second population of second composite particles, each of the second composite particles comprising silicon and carbon; and (A3) mixing at least the first population and the second population in accordance with a population mass fraction, the population mass fraction being defined as a mass of the first population divided by a sum of the mass of the first population and a mass of the second population, to form the battery electrode composition, wherein: the first population is characterized by a first particle size distribution (PSD^{L}) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L} is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$α = \frac{{D}_{50}^{L}}{{D}_{50}^{S}} ,$$

the size ratio α being in a range of about 3.0 to about 6.0; and the population mass fraction is in a range of about 0.40 to about 0.95.

Clause 24. The method of clause 23, wherein: the D₅₀^{L} is in a range of about 7.0 to about 9.0.

Clause 25. The method of any of clauses 23 to 24, wherein: the size ratio α is in a range of about 3.8 to about 5.2.

Clause 26. The method of any of clauses 23 to 25, wherein: a mass fraction of the silicon in the first composite particles is in a range of about 3 wt. % to about 80 wt. %; and a mass fraction of the silicon in the second composite particles is in a range of about 3 wt. % to about 80 wt. %.

Clause 27. The method of any of clauses 23 to 26, wherein: the first composite particles are round; and the second composite particles are round.

Clause 28. The method of any of clauses 23 to 27, wherein the (A3) additionally comprises mixing a carbon-comprising functional additive with the first population and the second population to form the battery electrode composition.

Clause 29. The method of clause 28, wherein the carbon-comprising functional additive is selected from: carbon nanotubes, carbon nanofibers, carbon black, graphite, exfoliated graphite, graphene oxide, and graphene.

Clause 30. A method of making a battery electrode, the method comprising: (B1) making the battery electrode composition according to the method of clause 23; and (B2) casting a slurry comprising the battery electrode composition on or in a current collector to form the battery electrode, wherein the slurry comprises a binder.

Clause 31. A method of making a battery electrode, the method comprising: (C1) providing the battery electrode composition of clause 1; and (C2) casting a slurry comprising the battery electrode composition on or in a current collector to form the battery electrode, wherein the slurry comprises a binder.

Clause 32. A method of making a lithium-ion battery, the method comprising: (D1) making the battery electrode according to the method of clause 31, the battery electrode being configured as an anode and the current collector being configured as an anode current collector; (D2) providing or making a cathode disposed on or in a cathode current collector; and (D3) assembling a battery cell from the anode and the cathode and filling a space between the anode and the cathode with an electrolyte ionically coupling the anode and the cathode to form the lithium-ion battery.

Clause 33. A method of making a lithium-ion battery, the method comprising: (F1) making the battery electrode according to the method of clause 30, the battery electrode being configured as an anode and the current collector being configured as an anode current collector; (F2) providing or making a cathode disposed on or in a cathode current collector; and (F3) assembling a battery cell from the anode and the cathode and filling a space between the anode and the cathode with an electrolyte ionically coupling the anode and the cathode to form the lithium-ion battery.

Clause 34. A method of making a lithium-ion battery, the method comprising: (E1) providing the battery electrode of clause 17, the battery electrode being configured as an anode and the current collector being configured as an anode current collector; (E2) providing or making a cathode disposed on or in a cathode current collector; and (E3) assembling a battery cell from the anode and the cathode and filling a space between the anode and the cathode with an electrolyte ionically coupling the anode and the cathode to form the lithium-ion battery.

Further implementation examples are described in the following numbered Additional Clauses:

Additional Clause 1. A battery electrode composition, comprising: a population of composite particles, each of the composite particles comprising silicon and carbon; wherein: the population is characterized by a mass fraction of the silicon in the composite particles in a range of about 35 wt. % to about 70 wt. %; the population is characterized by a particle size distribution (PSD) as determined by laser particle size distribution analysis (LPSA) such that; a tenth-percentile volume-weighted particle size parameter (D₁₀) of the PSD is in a range of about 0.8 μm to about 5.8 μm; a fiftieth-percentile volume-weighted particle size parameter (D₅₀) of the PSD is in a range of about 2.0 μm to about 9.0 μm; a ninetieth-percentile volume-weighted particle size parameter (D₉₀) of the PSD is at least about 3.2 μm; a left width (D₅₀−D₁₀) of the PSD is at least about 1.0 μm; and a right width (D₉₀−D₅₀) of the PSD is at least about 1.8 μm.

Additional Clause 2. The battery electrode composition of Additional Clause 1, wherein: the D₁₀ is in a range of about 0.8 μm to about 4.8 μm.

Additional Clause 3. The battery electrode composition of Additional Clause 2, wherein: the D₁₀ is in a range of about 0.8 μm to about 4.5 μm.

Additional Clause 4. The battery electrode composition of any of Additional Clauses 1 to 3, wherein: the D₅₀ is in a range of about 2.7 μm to about 7.7 μm.

Additional Clause 5. The battery electrode composition of Additional Clause 4, wherein: the D₅₀ is in a range of about 2.7 μm to about 7.3 μm.

Additional Clause 6. The battery electrode composition of any of Additional Clauses 1 to 5, wherein: the Doo is at least about 5.0 μm.

Additional Clause 7. The battery electrode composition of Additional Clause 6, wherein: the Doo is at least about 8.0 μm.

Additional Clause 8. The battery electrode composition of any of Additional Clauses 1 to 7, wherein: the left width (D₅₀−D₁₀) is at least about 1.5 μm.

Additional Clause 9. The battery electrode composition of Additional Clause 8, wherein: the left width (D₅₀−D₁₀) is at least about 3.3 μm.

Additional Clause 10. The battery electrode composition of any of Additional Clauses 1 to 9, wherein: the right width (D₉₀−D₅₀) is at least about 3.8 μm.

Additional Clause 11. The battery electrode composition of Additional Clause 10, wherein: the right width (D₉₀−D₅₀) is at least about 4.4 μm.

Additional Clause 12. The battery electrode composition of any of Additional Clauses 1 to 11, wherein: the mass fraction of the silicon is in a range of about 40 wt. % to about 55 wt. %.

Additional Clause 13. The battery electrode composition of any of Additional Clauses 1 to 12, wherein: a Brunauer-Emmett-Teller (BET) specific surface area of the composite particles is in a range of about 1.5 m²/g to about 14.0 m²/g.

Additional Clause 14. The battery electrode composition of Additional Clause 13, wherein: the BET specific surface area is in a range of about 2.3 m²/g to about 8.0 m²/g.

Additional Clause 15. The battery electrode composition of any of Additional Clauses 1 to 14, wherein the composite particles are spheroidal.

Additional Clause 16. A battery electrode, comprising: the battery electrode composition of Additional Clause 1 disposed on and/or in a current collector, wherein: the battery electrode comprises a binder.

Additional Clause 17. The battery electrode of Additional Clause 16, further comprising: a carbon-comprising functional additive.

Additional Clause 18. The battery electrode of Additional Clause 17, wherein the carbon-comprising functional additive is selected from: carbon nanotubes, carbon nanofibers, carbon black, graphite, exfoliated graphite, graphene oxide, and graphene.

Additional Clause 19. The battery electrode of Additional Clause 18, wherein a mass fraction of the carbon-comprising functional additive is about 1.0 wt. % or less of a mass of the battery electrode.

Additional Clause 20. The battery electrode of Additional Clause 19, wherein the mass fraction of the carbon-comprising functional additive is about 0.2 wt. % or less.

Additional Clause 21. A lithium-ion battery, comprising: an anode current collector; a cathode current collector; the battery electrode of Additional Clause 16 configured as an anode, the current collector thereof being configured as the anode current collector; a cathode disposed on or in the cathode current collector; and an electrolyte ionically coupling the anode and the cathode.

Additional Clause 22. The lithium-ion battery of Additional Clause 21, wherein the composite particles contribute 100% of a capacity of the anode.

Additional Clause 23. A method of making a lithium-ion battery, the method comprising: (E1) providing the battery electrode of Additional Clause 16, the battery electrode being configured as an anode and the current collector being configured as an anode current collector; (E2) providing or making a cathode disposed on or in a cathode current collector; and (E3) assembling a battery cell from the anode and the cathode and filling a space between the anode and the cathode with an electrolyte ionically coupling the anode and the cathode to form the lithium-ion battery.

Additional Clause 24. A method of making a battery electrode, the method comprising: (C1) providing the battery electrode composition of Additional Clause 1; and (C2) casting a slurry comprising the battery electrode composition on or in a current collector to form the battery electrode, wherein the slurry comprises a binder.

Additional Clause 25. A method of making a lithium-ion battery, the method comprising: (D₁) making the battery electrode according to the method of Additional Clause 24, the battery electrode being configured as an anode and the current collector being configured as an anode current collector; (D₂) providing or making a cathode disposed on or in a cathode current collector; and (D₃) assembling a battery cell from the anode and the cathode and filling a space between the anode and the cathode with an electrolyte ionically coupling the anode and the cathode to form the lithium-ion battery.

Additional Clause 26. A method of making a battery electrode composition, comprising: (A1) providing a first population of first composite particles, each of the first composite particles comprising silicon and carbon; (A2) providing a second population of second composite particles, each of the second composite particles comprising silicon and carbon; and (A3) mixing at least the first population and the second population in accordance with a population mass fraction, the population mass fraction being defined as a mass of the first population divided by a sum of the mass of the first population and a mass of the second population, to form the battery electrode composition, wherein: the first population is characterized by a first particle size distribution (PSD^{L}) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L} is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$\frac{{D}_{50}^{L}}{{D}_{50}^{S}} ,$$

the size ratio α being in a range of about 3.0 to about 6.0; and the population mass fraction is in a range of about 0.40 to about 0.95.

Additional Clause 27. The method of Additional Clause 26, wherein: the Do is in a range of about 7.0 μm to about 9.0 μm.

Additional Clause 28. The method of any of Additional Clauses 26 to 27, wherein: the size ratio α is in a range of about 3.8 to about 5.2.

Additional Clause 29. The method of any of Additional Clauses 26 to 28, wherein: a mass fraction of the silicon in the first composite particles is in a range of about 3 wt. % to about 80 wt. %; and a mass fraction of the silicon in the second composite particles is in a range of about 3 wt. % to about 80 wt. %.

Additional Clause 30. The method of any of Additional Clauses 26 to 29, wherein: the first composite particles are spheroidal; and the second composite particles are spheroidal.

Additional Clause 31. The method of any of Additional Clauses 26 to 30, wherein the (A3) additionally comprises mixing a carbon-comprising functional additive with the first population and the second population to form the battery electrode composition.

Additional Clause 32. The method of Additional Clause 31, wherein the carbon-comprising functional additive is selected from: carbon nanotubes, carbon nanofibers, carbon black, graphite, exfoliated graphite, graphene oxide, and graphene.

Additional Clause 33. A method of making a battery electrode, the method comprising: (B1) making the battery electrode composition according to the method of any of Additional Clauses 23 to 32; and (B2) casting a slurry comprising the battery electrode composition on and/or in a current collector to form the battery electrode, wherein the slurry comprises a binder.

Additional Clause 34. A method of making a lithium-ion battery, the method comprising: (F1) making the battery electrode according to the method of Additional Clause 33, the battery electrode being configured as an anode and the current collector being configured as an anode current collector; (F2) providing or making a cathode disposed on or in a cathode current collector; and (F3) assembling a battery cell from the anode and the cathode and filling a space between the anode and the cathode with an electrolyte ionically coupling the anode and the cathode to form the lithium-ion battery.

Additional Clause 35. A battery electrode composition, comprising: a first population of first composite particles, each of the first composite particles comprising silicon and carbon; and a second population of second composite particles, each of the second composite particles comprising silicon and carbon; wherein: the first population and the second population are characterized by a population mass fraction being defined as a mass of the first population divided by a sum of the mass of the first population and a mass of the second population; the first population is characterized by a first particle size distribution (PSD^{L}.) as determined by laser particle size distribution analysis (LPSA); the second population is characterized by a second particle size distribution (PSD^{S}) as determined by the LPSA; a fiftieth-percentile volume-weighted particle size parameter (D₅₀^{L}) of the PSD^{L} is in a range of about 6.0 μm to about 10.0 μm; a fiftieth-percentile volume-weighted particle size parameter (D₅₀^{S}) of the PSD^{S} is related to the D₅₀^{L} by a size ratio α defined as

$$\frac{{D}_{50}^{L}}{{D}_{50}^{S}} ,$$

the size ratio α being in a range of about 3.0 to about 6.0; and the population mass fraction is in a range of about 0.40 to about 0.95.

Additional Clause 36. The battery electrode composition of Additional Clause 35, wherein: the D₅₀^{L}, is in a range of about 7.0 μm to about 9.0 μm.

Additional Clause 37. The battery electrode composition of any of Additional Clauses 35 to 36, wherein: the size ratio α is in a range of about 3.8 to about 5.2.

Additional Clause 38. The battery electrode composition of any of Additional Clauses 35 to 37, wherein: a mass fraction of the silicon in the first composite particles is in a range of about 3 wt. % to about 80 wt. %; and a mass fraction of the silicon in the second composite particles is in a range of about 3 wt. % to about 80 wt. %.

Additional Clause 39. The battery electrode composition of any of Additional Clauses 35 to 38, wherein: the first composite particles are spheroidal; and the second composite particles are spheroidal.

Additional Clause 40. The battery electrode composition of any of Additional Clauses 35 to 39, further comprising: a carbon-comprising functional additive.

Additional Clause 41. The battery electrode composition of Additional Clause 40, wherein the carbon-comprising functional additive is selected from: carbon nanotubes, carbon nanofibers, carbon black, graphite, exfoliated graphite, graphene oxide, and graphene.

Additional Clause 42. The battery electrode composition of any of Additional Clauses 35 to 41, wherein the battery electrode position is in the form of a dry powder, a slurry suspension, or a casted electrode, or a lithium-ion battery.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A battery electrode composition, comprising:
a population of composite particles, each of the composite particles comprising silicon and carbon;
wherein:
the population is characterized by a mass fraction of the silicon in the composite particles in a range of about 35 wt. % to about 70 wt. %;
the population is characterized by a particle size distribution (PSD) as determined by laser particle size distribution analysis (LPSA) such that;
a tenth-percentile volume-weighted particle size parameter (D₁₀) of the PSD is in a range of about 0.8 μm to about 5.8 μm;
a fiftieth-percentile volume-weighted particle size parameter (D₅₀) of the PSD is in a range of about 2.0 μm to about 9.0 μm;
a ninetieth-percentile volume-weighted particle size parameter (D₉₀) of the PSD is at least about 3.2 μm;
a left width (D₅₀−D₁₀) of the PSD is at least about 1.0 μm; and
a right width (D₉₀−D₅₀) of the PSD is at least about 1.8 μm.

2. The battery electrode composition of claim 1, wherein:
the D₁₀ is in a range of about 0.8 μm to about 4.8 μm.

3. The battery electrode composition of claim 2, wherein:
the D₁₀ is in a range of about 0.8 μm to about 4.5 μm.

4. The battery electrode composition of claim 1, wherein:
the D₅₀ is in a range of about 2.7 μm to about 7.7 μm.

5. The battery electrode composition of claim 4, wherein:
the D₅₀ is in a range of about 2.7 μm to about 7.3 μm.

6. The battery electrode composition of claim 1, wherein:
the D₉₀ is at least about 5.0 μm.

7. The battery electrode composition of claim 6, wherein:
the D₉₀ is at least about 8.0 μm.

8. The battery electrode composition of claim 1, wherein:
the left width (D₅₀−D₁₀) is at least about 1.5 μm.

9. The battery electrode composition of claim 8, wherein:
the left width (D₅₀−D₁₀) is at least about 3.3 μm.

10. The battery electrode composition of claim 1, wherein:
the right width (D₉₀−D₅₀) is at least about 3.8 μm.

11. The battery electrode composition of claim 10, wherein:
the right width (D₉₀−D₅₀) is at least about 4.4 μm.

12. The battery electrode composition of claim 1, wherein:
the mass fraction of the silicon is in a range of about 40 wt. % to about 55 wt. %.

13. The battery electrode composition of claim 1, wherein:
a Brunauer-Emmett-Teller (BET) specific surface area of the composite particles is in a range of about 1.5 m²/g to about 14.0 m²/g.

14. The battery electrode composition of claim 13, wherein:
the BET specific surface area is in a range of about 2.3 m²/g to about 8.0 m²/g.

15. The battery electrode composition of claim 1, wherein the composite particles are spheroidal.

16. A battery electrode, comprising:
the battery electrode composition of claim 1 disposed on and/or in a current collector,
wherein:
the battery electrode comprises a binder.

17. The battery electrode of claim 16, further comprising:
a carbon-comprising functional additive.

18. The battery electrode of claim 17, wherein the carbon-comprising functional additive is selected from: carbon nanotubes, carbon nanofibers, carbon black, graphite, exfoliated graphite, graphene oxide, and graphene.

19. The battery electrode of claim 18, wherein a mass fraction of the carbon-comprising functional additive is about 1.0 wt. % or less of a mass of the battery electrode.

20. The battery electrode of claim 19, wherein the mass fraction of the carbon-comprising functional additive is about 0.2 wt. % or less.

21. A lithium-ion battery, comprising:
an anode current collector;
a cathode current collector;
the battery electrode of claim 16 configured as an anode, the current collector thereof being configured as the anode current collector;
a cathode disposed on or in the cathode current collector; and
an electrolyte ionically coupling the anode and the cathode.

22. The lithium-ion battery of claim 21, wherein the composite particles contribute 100% of a capacity of the anode.

23. A method of making a lithium-ion battery, the method comprising:
(E1) providing the battery electrode of claim 16, the battery electrode being configured as an anode and the current collector being configured as an anode current collector;
(E2) providing or making a cathode disposed on or in a cathode current collector; and
(E3) assembling a battery cell from the anode and the cathode and filling a space between the anode and the cathode with an electrolyte ionically coupling the anode and the cathode to form the lithium-ion battery.

24. A method of making a battery electrode, the method comprising:
(C1) providing the battery electrode composition of claim 1; and
(C2) casting a slurry comprising the battery electrode composition on or in a current collector to form the battery electrode,
wherein the slurry comprises a binder.

25. A method of making a lithium-ion battery, the method comprising:
(D1) making the battery electrode according to the method of claim 24, the battery electrode being configured as an anode and the current collector being configured as an anode current collector;
(D2) providing or making a cathode disposed on or in a cathode current collector; and
(D3) assembling a battery cell from the anode and the cathode and filling a space between the anode and the cathode with an electrolyte ionically coupling the anode and the cathode to form the lithium-ion battery.

26. A method of making a battery electrode composition, comprising:
(A1) providing a first population of first composite particles, each of the first composite particles comprising silicon and carbon;
(A2) providing a second population of second composite particles, each of the second composite particles comprising silicon and carbon; and
(A3) mixing at least the first population and the second population in accordance with a population mass fraction, the population mass fraction being defined as a mass of the first population divided by a sum of the mass of the first population and a mass of the second population, to form the battery electrode composition,
wherein:
the first population is characterized by a first particle size distribution (PSD^{L}) as determined by laser particle size distribution analysis (LPSA);
the second population is characterized by a second particle size distribution (PSD^{S}) as determined by the LPSA;
a fiftieth-percentile volume-weighted particle size parameter (D₅₀^{L}) of the PSD^{L} is in a range of about 6.0 μm to about 10.0 μm;
a fiftieth-percentile volume-weighted particle size parameter (D₅₀^{S}) of the PSD^{S} is related to the D₅₀^{L} by a size ratio α defined as
$$\frac{{D}_{50}^{L}}{{D}_{50}^{S}} ,$$
the size ratio α being in a range of about 3.0 to about 6.0; and
the population mass fraction is in a range of about 0.40 to about 0.95.

27. The method of claim 26, wherein:
the D₅₀^{L}, is in a range of about 7.0 μm to about 9.0 μm.

28. The method of claim 26, wherein:
the size ratio α is in a range of about 3.8 to about 5.2.

29. The method of claim 26, wherein:
a mass fraction of the silicon in the first composite particles is in a range of about 3 wt. % to about 80 wt. %; and
a mass fraction of the silicon in the second composite particles is in a range of about 3 wt. % to about 80 wt. %.

30. The method of claim 26, wherein:
the first composite particles are spheroidal; and
the second composite particles are spheroidal.

31. The method of claim 26, wherein the (A3) additionally comprises mixing a carbon-comprising functional additive with the first population and the second population to form the battery electrode composition.

32. The method of claim 31, wherein the carbon-comprising functional additive is selected from: carbon nanotubes, carbon nanofibers, carbon black, graphite, exfoliated graphite, graphene oxide, and graphene.

33. A method of making a battery electrode, the method comprising:
(B1) making the battery electrode composition according to the method of claim 26; and
(B2) casting a slurry comprising the battery electrode composition on and/or in a current collector to form the battery electrode,
wherein the slurry comprises a binder.

34. A method of making a lithium-ion battery, the method comprising:
(F1) making the battery electrode according to the method of claim 33, the battery electrode being configured as an anode and the current collector being configured as an anode current collector;
(F2) providing or making a cathode disposed on or in a cathode current collector; and
(F3) assembling a battery cell from the anode and the cathode and filling a space between the anode and the cathode with an electrolyte ionically coupling the anode and the cathode to form the lithium-ion battery.

35. A battery electrode composition, comprising:
a first population of first composite particles, each of the first composite particles comprising silicon and carbon; and
a second population of second composite particles, each of the second composite particles comprising silicon and carbon;
wherein:
the first population and the second population are characterized by a population mass fraction being defined as a mass of the first population divided by a sum of the mass of the first population and a mass of the second population;
the first population is characterized by a first particle size distribution (PSD^{L}) as determined by laser particle size distribution analysis (LPSA);
the second population is characterized by a second particle size distribution (PSD^{S}) as determined by the LPSA;
a fiftieth-percentile volume-weighted particle size parameter (D₅₀^{L}) of the PSD^{L} is in a range of about 6.0 μm to about 10.0 μm;
a fiftieth-percentile volume-weighted particle size parameter (D₅₀^{S}) of the PSD^{S} is related to the D₅₀^{L} by a size ratio α defined as
$$\frac{{D}_{50}^{L}}{{D}_{50}^{S}} ,$$
the size ratio α being in a range of about 3.0 to about 6.0; and
the population mass fraction is in a range of about 0.40 to about 0.95.

36. The battery electrode composition of claim 35, wherein:
the D₅₀^{L} is in a range of about 7.0 μm to about 9.0 μm.

37. The battery electrode composition of claim 35, wherein:
the size ratio α is in a range of about 3.8 to about 5.2.

38. The battery electrode composition of claim 35, wherein:
a mass fraction of the silicon in the first composite particles is in a range of about 3 wt. % to about 80 wt. %; and
a mass fraction of the silicon in the second composite particles is in a range of about 3 wt. % to about 80 wt. %.

39. The battery electrode composition of claim 35, wherein:
the first composite particles are spheroidal; and
the second composite particles are spheroidal.

40. The battery electrode composition of claim 35, further comprising:
a carbon-comprising functional additive.

41. The battery electrode composition of claim 40, wherein the carbon-comprising functional additive is selected from: carbon nanotubes, carbon nanofibers, carbon black, graphite, exfoliated graphite, graphene oxide, and graphene.

42. The battery electrode composition of claim 35, wherein the battery electrode position is in the form of a dry powder, a slurry suspension, or a casted electrode, or a lithium-ion battery.
